(19) United States
(12) Patent Application Publication
(10) Pub. No.: US 2014/0083462 A1
(43) Pub. Date: Mar. 27, 2014

(54) Gas Expansion Displacement CNX Concept, Methods and Apparatus

(71) Applicant: Advanced Wet Technologies GmbH, Huefingen (DE)

(72) Inventor: Richard W. Plavidal, Milpitas, CA (US)

(73) Assignee: Advanced Wet Technologies GmbH, Huefingen (DE)

(21) Appl. No.: 14/037,327

(22) Filed: Sep. 25, 2013

Related U.S. Application Data
(60) Provisional application No. 61/705,613, filed on Sep. 25, 2012.
(60) Provisional application No. 61/705,617, filed on Sep. 25, 2012.
(60) Provisional application No. 61/705,619, filed on Sep. 25, 2012.

(51) Int. Cl. B08B 3/04; B08B 7/04

(52) U.S. Cl. CPC B08B 3/04; B08B 7/04
USPC 134/19; 134/34

(57) ABSTRACT

A cyclic bubble generation and termination process can be used to effectively clean objects in a liquid. The bubbles can be generated from dissolved gas in the liquid during a pressurizing phase of the cyclic bubble process. Alternatively, the bubbles can be generated from as a by-product in a chemical reaction between chemicals in the liquid and material or chemicals at the surface of a part being processed. A vacuum process or a hyperbaric process can be used for cycling the pressure.

This application claims priority from U.S. provisional patent application Ser. No. 61/705,613, filed on Sep. 25, 2012, entitled “Gas Expansion Displacement CNX Concept, Methods and Apparatus”, from U.S. provisional patent application Ser. No. 61/705,617, filed on Sep. 25, 2012, entitled “Gas Expansion Displacement CNX Concept, Methods and Apparatus”, from U.S. provisional patent application Ser. No. 61/705,619, filed on Sep. 25, 2012, entitled “Gas Expansion Displacement CNX Concept, Methods and Apparatus”, which are incorporated herein by reference.

This application is related to co-pending U.S. application Ser. No. 13/733,119, filed on Jan. 2, 2013, entitled “Methods and systems for cleaning for cyclic nucleation transport (CNX)”, which is incorporated herein by reference.

This application is related to co-pending U.S. application Ser. No. 13/733,120, filed on Jan. 2, 2013, entitled “Methods and systems for cleaning for cyclic nucleation transport (CNX)”, which is incorporated herein by reference.

This application is related to co-pending U.S. application Ser. No. 13/733,122, filed on Jan. 2, 2013, entitled “Methods and systems for cleaning for cyclic nucleation transport (CNX)”, which is incorporated herein by reference.

This application is related to co-pending U.S. application Ser. No. 13/888,338, filed on May 6, 2013, entitled “Hyperbaric Methods and Systems for Surface Treatment, Cleaning, and Drying”, which is incorporated herein by reference.

This application is related to co-pending U.S. application Ser. No. 13/888,343, filed on May 6, 2013, entitled “Hyperbaric Methods and Systems for Surface Treatment, Cleaning, and Drying”, which is incorporated herein by reference.

This application is related to co-pending U.S. application Ser. No. 13/865,176, filed on Apr. 17, 2013, entitled “Dynamic chamber for cycle nucleation technology”, which is incorporated herein by reference.

### BACKGROUND

Parts or devices with complex shapes pose a special challenge for cleaning due to small openings, internal dead spaces, blind holes and other hard to access places within the part. Traditional sprays and sonic agitation cannot access these areas effectively and even if they could it would be difficult or impossible to remove loosened debris and contaminated cleaning solutions from these parts. Even complex manifold flow connections cannot effectively flush contamination from trapped areas and dead spaces within some parts.

### SUMMARY OF THE EMBODIMENTS

In some embodiments, the current invention discloses methods and systems for cyclically processing an object using non-vapor gas bubbles inside a process chamber. These non-vapor gas bubbles may be rapidly expanded and compressed in pressure-controlled cycles and can assist in the transport of fluids, particles, and by-products to and from surfaces. The non-vapor gas can be provided during a pressurizing cycle, which can be dissolved in the liquids. The dissolved gas can be released during the vacuum cycle, e.g., a lower pressure condition than the pressurizing cycle, for cleaning the object.

In some embodiments, pressurized gas can be used to supply gases to the liquid. A vacuum pump can be used to generate the vacuum cycles. In some embodiments, a hyperbaric chamber can be used, in which the liquid and dissolved gases are under pressures higher that atmospheric pressure. In some embodiments, a piston can be used to cycling the pressure in the process chamber.

In some embodiments, the current invention discloses methods and systems for cleaning objects with dissolved gases, in which the gases can be produced as a by-product in a chemical reaction between chemicals in the liquid and material at the surface of a part being processed. For example, in a silicon etch process, KOH can react with silicon surface of parts having silicon material to generate a gaseous byproduct. Or H₂O₂ can react with bio-matter contamination on the surface of a part to be cleaned to generate a gaseous byproduct. Alternatively, gases can be produced in a chemical reaction between different chemicals contained in the liquid. For example, a piranha solution, i.e., a mixture of sulfuric acid and hydrogen peroxide, can produce gases byproducts due to the reaction of sulfuric acid with hydrogen peroxide.

In some embodiments, the current invention discloses methods and systems for cleaning objects with dissolved gases, in which gases can be produced as a by-product in a chemical reaction between chemicals in the liquid and chemicals at the surface of a part being processed. For example, an object wetted with H₂O₂ can have the H₂O₂ on the object surface reacting with the sulfuric acid in the container tank. Alternatively, an object wetted with sulfuric acid can have the sulfuric acid reacting with the H₂O₂ in the container tank. The reaction between H₂O₂ and sulfuric acid can generate gaseous byproducts, and thus the reaction can be suppressed, for example, by a high pressure environment, and accelerated, for example, by a high vacuum environment.

### BRIEF DESCRIPTION OF THE DRAWINGS

FIGS. 1A-1D illustrate an example of CNX using dissolved gases according to some embodiments of the current invention.

FIGS. 2A-2C illustrate another example of CNX using dissolved gases according to some embodiments of the current invention.

FIG. 3 illustrates a flowchart example of CNX using dissolved gases according to some embodiments of the current invention.

FIGS. 4A-4D illustrate process examples for pressurizing a chamber according to some embodiments of the current invention.

FIGS. 5A-5C illustrate process examples for reducing pressure in a chamber according to some embodiments of the current invention.

FIGS. 6A-6C illustrate an example of a cyclic nucleation process according to some embodiments of the current invention.

FIGS. 7A-7C illustrate another example of a cyclic nucleation process according to some embodiments of the current invention.

FIG. 8 illustrates another flowchart example of CNX using dissolved gases according to some embodiments of the current invention.

FIG. 9 illustrates a flowchart example of CNX using dissolved gases according to some embodiments of the current invention.

FIG. 10 illustrates an example configuration of a process chamber having temperature gradient according to some embodiments of the current invention.

FIG. 11 illustrates a flowchart example of CNX using temperature gradient according to some embodiments of the current invention.

FIGS. 12A-12C illustrate an example of a dynamic chamber operation according to some embodiments of the current invention.

FIG. 13 illustrates a flowchart example of CNX using dynamic chamber according to some embodiments of the current invention.

FIGS. 14A-14C illustrate another example of a dynamic chamber operation according to some embodiments of the current invention.

FIG. 15 illustrates a flowchart example of CNX using dynamic chamber according to some embodiments of the current invention.

FIGS. 16A-16B illustrate an example of CNX using a gaseous reaction between a liquid and the object to be cleaned according to some embodiments of the current invention.

FIG. 17 illustrates a flowchart example of CNX using a gaseous reaction between a liquid and the object to be cleaned according to some embodiments of the current invention.

FIGS. 18A-18D illustrate an example of CNX using a gaseous reaction between two different liquids according to some embodiments of the current invention.

FIG. 19 illustrates another flowchart example of CNX using dissolved gases according to some embodiments of the current invention.

FIG. 20 illustrates an example configuration of a process chamber having temperature gradient according to some embodiments of the current invention.

FIG. 21 illustrates a flowchart example of CNX using temperature gradient according to some embodiments of the current invention.

FIG. 22 illustrates another flowchart example of CNX using temperature gradient according to some embodiments of the current invention.

FIGS. 23A-23C illustrate an example of a dynamic chamber operation according to some embodiments of the current invention.

FIG. 24 illustrates a flowchart example of CNX using dynamic chamber according to some embodiments of the current invention.

FIGS. 25A-25C illustrate another example of a dynamic chamber operation according to some embodiments of the current invention.

FIG. 26 illustrates a flowchart example of CNX using dynamic chamber according to some embodiments of the current invention.

FIG. 27 illustrates another flowchart example of CNX using dynamic chamber according to some embodiments of the current invention.

FIG. 28 illustrates another flowchart example of CNX using dynamic chamber according to some embodiments of the current invention.

FIGS. 29A-29C illustrate an example of CNX using a gaseous reaction between a liquid in a container and a liquid on an object surface according to some embodiments of the current invention.

FIG. 30 illustrates a flowchart example of CNX using a gaseous reaction between a liquid in a container and a liquid on an object surface according to some embodiments of the current invention.

FIGS. 31A-31C illustrate an example of a dynamic chamber operation according to some embodiments of the current invention.

FIG. 32 illustrates a flowchart example of CNX using dynamic chamber according to some embodiments of the current invention.

FIG. 33 illustrates a flowchart example of CNX using dynamic chamber according to some embodiments of the current invention.

FIGS. 34A-34D illustrate an example of object wetting according to some embodiment of the present invention

FIGS. 35A-35C illustrate an example of an object wetting process according to some embodiments of the current invention

FIGS. 36A-36C illustrate an example of an object wetting process according to some embodiments of the current invention.

FIGS. 37A-37C illustrate an example of an object wetting process according to some embodiments of the current invention.

FIGS. 38A-38C illustrate an example of an object wetting process according to some embodiments of the current invention.

FIG. 39 illustrates a flowchart example of CNX using a gaseous reaction between a liquid in a container and a liquid on an object surface according to some embodiments of the current invention.

FIG. 40 illustrates a flowchart example of CNX using a gaseous reaction between a liquid in a container and a liquid on an object surface according to some embodiments of the current invention.

### DETAILED DESCRIPTION OF THE PREFERRED EMBODIMENTS

The development of CNX (Cycle Nucleation Transport) Technology represented a breakthrough in addressing the aforementioned problem. With CNX it was possible to grow and collapse vapor bubbles which would displace fluids and dislodge contamination from hidden surfaces independent of boundary layers and geometries which would otherwise block any cleaning agitation or displacement. A key attribute of CNX is that all surfaces see the same pressure in a pressure controlled environment. Therefore, vapor bubbles will be created at any surface, whether hidden from direct view or not. As long as the pressure is held below the fluid vapor pressure, nucleation continues unabated and displacement currents continue to flow. Upon re-pressurization the vapor bubbles collapse and bring both fresh fluid and kinetic energy to the surface.

CNX technology can include cyclic nucleation, which involves vapor bubble nucleation through various means and conditions. A vapor can be distinguished from a non-vapor gas in that it can be readily condensable into its liquid state. A non-condensable gas tends to remain in a gas state, it may be a partially soluble in a liquid, such as CO2 in water, but it is not a readily condensable vapor such as saturated steam vapor condensing into water.

In some embodiments, the current invention discloses various methods to create and employ the use of non-vapor, non-condensable gas bubbles inside a process chamber. These non-vapor gas bubbles may be rapidly expanded and compressed in pressure-controlled cycles and can assist in the transport of fluids, particles, and by-products to and from surfaces. In particular, the nucleation site for gas or vapor bubbles can prefer discontinuous or contaminated surfaces and can effectively form inside tubes, holes and dead spaces found in complex 3D part structures where conventional sprays, sonic waves, brushes cannot reach.

In some embodiments, non-vapor gasses can be dissolved in the liquids, for example, CO₂ in water, for cyclic nucleation process.

In some embodiments, a vacuum pump can be used to reduce pressures to sub-atmospheric which can lead to vapor bubble nucleation as well as the expansion and displacement of non-vapor gas byproduct bubbles and/or the release of dissolved gasses into expanding bubbles. Vacuum cyclic nucleation can be suitable for delicate parts and temperature-limited applications.

In some embodiments, a hyperbaric chamber can be used, in which the liquid and dissolved gases are under pressures higher that atmospheric pressure. Pressure reduction cycles can be accomplished by releasing pressure through a control valve to atmospheric pressure. Since hyperbaric cyclic nucleation works in hyperbaric pressure range, there can be a greater drop in pressure than is possible with a vacuum system. This is because a vacuum system only has a pressure range from zero to 1 atmosphere whereas a hyperbaric system operates in a much greater pressure range from 1 to 16 atmospheres or more. Hence hyperbaric cyclic nucleation may provide a more powerful cleaning process.

In some embodiments, dynamic chamber cyclic nucleation technology can be used, in which pressure is cycled to produce cyclic nucleation transport and gas expansion displacement. The volume of a process chamber can be directly cycled to produce the instantaneous pressure changes that produce cyclic nucleation transport and gas expansion displacement.

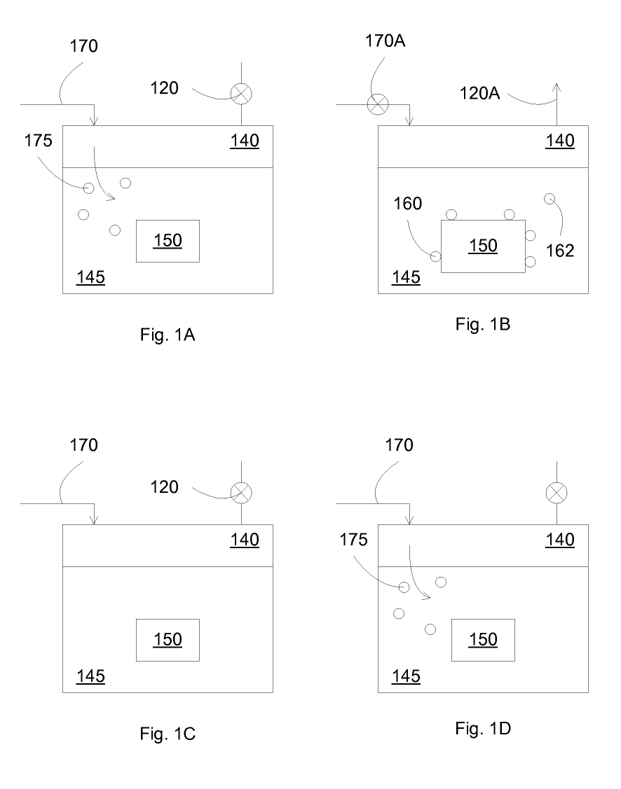

FIGS. 1A-1D illustrate an example of CNX using dissolved gases according to some embodiments of the current invention. In FIG. 1A, an object 150 is submerged in a liquid 145 in a process chamber. As shown, the object is fully submerged. Other configurations can also be used, such as an object partially submerged in the liquid. A vapor portion 140 can be present above the liquid portion 145. The vapor portion 140 can include a release valve 120, which is closed. A non-vapor gas 170 can be provided to the vapor portion 140, pressurizing the vapor portion. Some gases 175 can be dissolved in the liquid 145. The gas 170 can be coupled to a pressurized cylinder, which can flow to the process chamber. The gas 170 can be any gases, such as CO₂, N₂, O₂, etc. The liquid can be any liquid, such as water, deionized water, solvent, cleaner, or a mixture of cleaning chemistry. In some embodiments, the gas and the liquid can be selected so that there is a high solubility of gas in the liquid, such as CO₂ in water.

In FIG. 1B, the gas delivery is stopped, for example, by closing valve 170A, after reaching a desired pressure. For example, the desired pressure can be such that any bubbles in the liquid can be suppressed or terminated. The pressure can be at atmospheric or at higher than atmospheric pressure, e.g., 10-25 atm. Release valve 120 is open, and gases 120A can escape from the process chamber. For example, a vacuum pump can be coupled to the release valve 120, and gases can be evacuated through the pumping action. Alternatively, the release valve 120 can be open to atmosphere, and higher than atmospheric pressure within the process chamber can be reduced to atmospheric pressure through gas flow 120A. With lower pressure in the vapor portion 140, bubbles 160 and 162 can be formed in the liquid 145. The bubbles can include the dissolved gases that have been provided to the liquid in earlier stages. In some embodiments, the process conditions can be monitored and adjusted to provide bubbles 160 at the surface of the object 150, and minimizing bubbles 162 in the liquid. In general, at the onset of bubble nucleation, bubbles 160 tend to nucleate at the object surface. At the advance stage of boiling, bubbles 162 can be nucleate within the liquid. Thus in some embodiments, the removal of gases in the vapor portion of the process chamber, e.g., through gas flow 120A, can be regulated or adjusted so maintain conditions for bubble nucleation at the object surface.

In FIG. 1C, release valve 120 is close, and gas 170 can be delivered to the process chamber. The gas flow 170 can pressurize the vapor portion 140, effectively terminating the bubbles 160 and 162. In FIG. 1D, gas 170 continues to flow, and gases 175 can be dissolved into the liquid 145. The process then continues, dissolving bubbles to liquid, generating the bubbles at the object surface, terminating the bubbles, and re-dissolving bubbles to the liquid. The cyclic generating and terminating bubbles at the object surface can clean the object, especially at hard to reach surfaces. The generated bubbles can be derived from the dissolved gases, thus minimum energy can be used in the process.

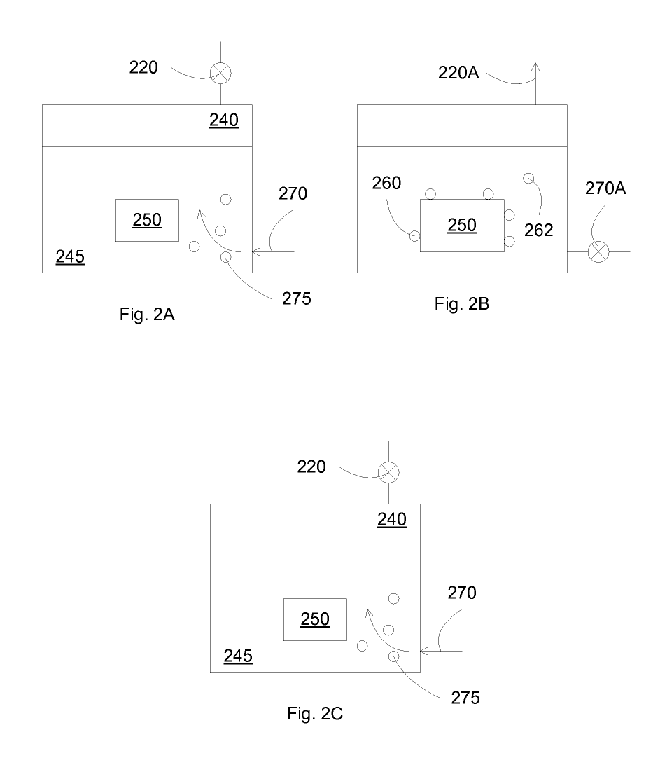

FIGS. 2A-2C illustrate another example of CNX using dissolved gases according to some embodiments of the current invention. In FIG. 2A, an object 250 is submerged in a liquid 245 in a process chamber. A vapor portion 240 can be present above the liquid portion 245. The vapor portion 240 can include a release valve 220, which is closed. A non-vapor gas 270 can be provided to the liquid portion 245, bubbling through the liquid 245. Some gases 275 can be dissolved in the liquid 245, and some gases can reach the vapor portion 240 to pressurize the vapor portion. The gas 270 can be coupled to a pressurized cylinder. The gas 270 can be any gases, such as CO₂, N₂, O₂, etc. The liquid can be any liquid, such as water, deionized water, solvent, cleaner, or a mixture of cleaning chemistry. In some embodiments, the gas and the liquid can be selected so that there is a high solubility of gas in the liquid, such as CO₂ in water. A bubble generation component can be used to generate bubbles in the liquid, such as a gas stone.

In FIG. 2B, the gas delivery is stopped, for example, by closing valve 270A, after reaching a desired pressure. For example, the desired pressure can be such that any bubbles in the liquid can be suppressed or terminated. The pressure can be at atmospheric or at higher than atmospheric pressure, e.g., 10-25 atm. Release valve 220 is open, and gases 220A can escape from the process chamber. For example, a vacuum pump can be coupled to the release valve 220, and gases can be evacuated through the pumping action. Alternatively, the release valve 220 can be open to atmosphere, and higher than atmospheric pressure within the process chamber can be reduced to atmospheric pressure through gas flow 220A. With lower pressure in the vapor portion 240, bubbles 260 and 262 can be formed in the liquid 245. The bubbles can include the dissolved gases that have been provided to the liquid in earlier stages. In some embodiments, the process conditions can be monitored and adjusted to provide bubbles 260 at the surface of the object 250, and minimizing bubbles 262 in the liquid. In some embodiments, the removal of gases in the vapor portion of the process chamber, e.g., through gas flow 220A, can be regulated or adjusted so maintain conditions for bubble nucleation at the object surface.

In FIG. 2C, release valve 220 is close, and gas 270 can be delivered to the process chamber. The gas flow 270 can pressurize the vapor portion 240, effectively terminating the bubbles 260 and 262. The gas flow 270 can bubble through the liquid, forming bubbles to be dissolved into the liquid 245. The process then continues, dissolving bubbles to liquid, generating the bubbles at the object surface, terminating the bubbles, and re-dissolving bubbles to the liquid. The cyclic generating and terminating bubbles at the object surface can clean the object, especially at hard to reach surfaces. The generated bubbles can be derived from the dissolved gases, thus minimum energy can be used in the process.

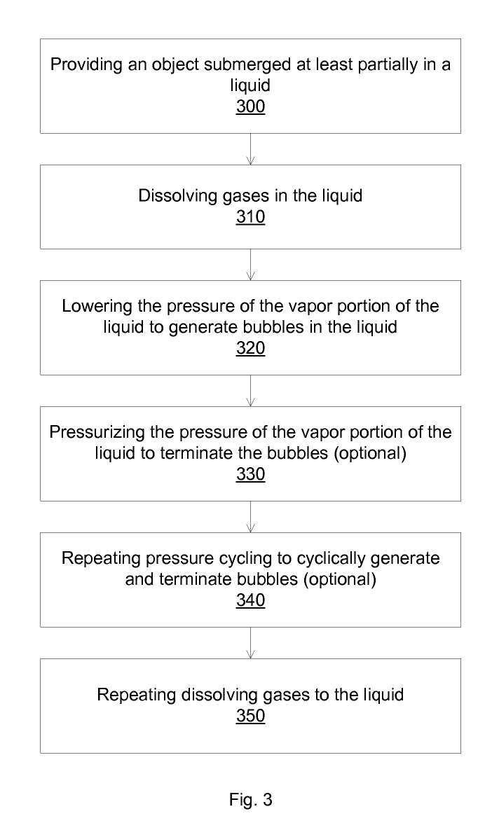

FIG. 3 illustrates a flowchart example of CNX using dissolved gases according to some embodiments of the current invention. In operation 300, an object is submerged at least partially in a liquid. The object can be submerged partially or fully in the liquid. In operation 310, gases are dissolved in the liquid. The gases can be delivered to the vapor portion above the liquid. The gases can be delivered to the liquid portion, bubbling through the liquid. The gases can be delivered to both gas and liquid portions. The gases can be provided from a pressurized cylinder. The gases can provide atmospheric pressure or above atmospheric pressure to the vapor portion. In operation 320, the pressure in the vapor portion is lowered to generate bubbles in the liquid, especially at the object surface. For example, the gases can be evacuated by an aspirator or a vacuum pump. The gases can be released to atmosphere by opening a release valve, if the vapor portion is pressurized to above atmospheric pressure.

In some embodiments, the vapor portion is pressurized, for example, by closing the release valve (operation 330). The bubbles can reach the vapor portion, and pressurizing the vapor portion. After reaching a certain pressure, the bubbles can be terminated. The pressure release and pressurizing can be repeated to cyclically generating and terminating bubbles (operation 340). For example, if the vapor portion is pressurized to above atmospheric pressure, the pressure cycling can be performed many times until the pressure reaches atmospheric pressure.

In operation 350, gases can be repeatedly dissolved in the liquid, for example, by flowing gases to the vapor and/or liquid portions of the liquid. The process can be continued until the object is cleaned.

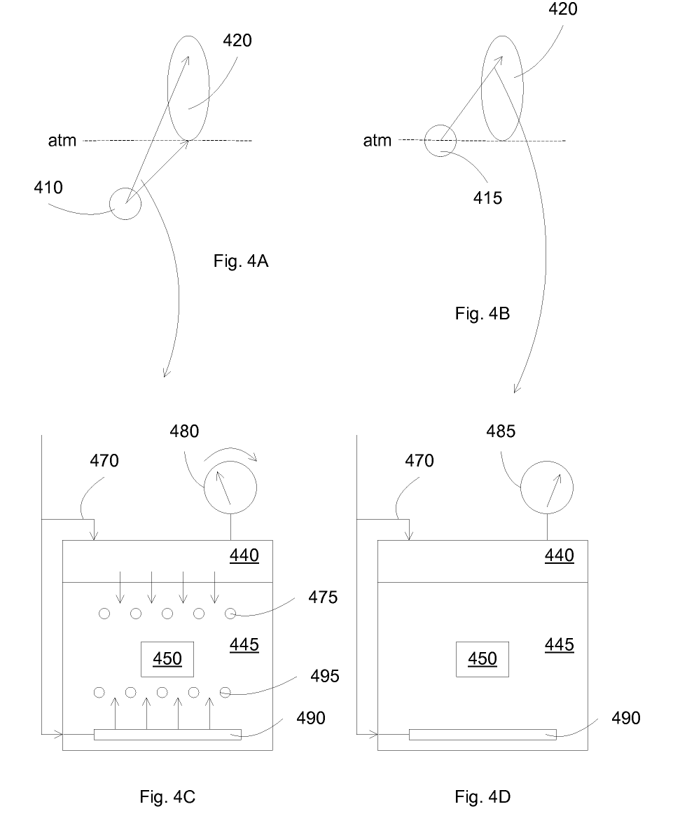

FIGS. 4A-4D illustrate process examples for pressurizing a chamber according to some embodiments of the current invention. In FIG. 4A, a low pressure regime 410 can be below atmospheric pressure, and gases can be introduced to bring the process chamber to a high pressure regime 420, which can be at or above atmospheric pressure. The pressure can start at a pressure lower than atmospheric pressure (e.g., in process regime 410) and increase to a higher pressure value, to atmospheric pressure or pressures higher than atmospheric pressure (e.g., in process regime 420). FIG. 4B shows another process example, in which a low pressure regime 415 can be at or around atmospheric pressure, and gases can be introduced to bring the process chamber to a high pressure regime 420, which can at or above atmospheric pressure. The pressure can start at atmospheric pressure (e.g., in process regime 415) and increase to a higher pressure value, to atmospheric pressure or pressures higher than atmospheric pressure (e.g., in process regime 420).

FIG. 4C shows an example of a process chamber at a beginning of the pressure increase. An object 450 is submerged (or partially submerged) in a liquid 445 in a process chamber. The liquid 445 can have a vapor portion 440 on the top surface of the liquid portion 445. The pressure 480 is low, as shown by the pressure monitor. Gases 470 can flow to the process chamber, at the vapor portion 440 and at the liquid portion 445, for example, through a porous element 490 for better distribution. Bubbles can be dissolved to the liquid, for example, bubbles 475 from the vapor portion 440 entering the liquid portion 445, or bubbles 495 from the porous element 490 entering the liquid portion 445.

FIG. 4D shows an example of a process chamber at an end of the pressure increase. The pressure 485 is high, as shown by the pressure monitor. The vapor portion can be filled with gases, and the liquid portion can have gases dissolved within.

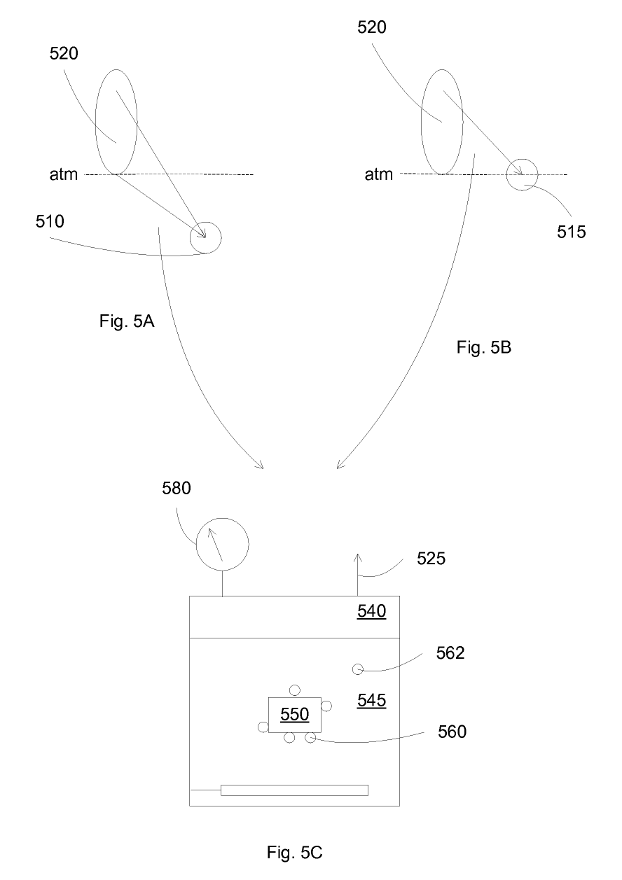

FIGS. 5A-5C illustrate process examples for reducing pressure in a chamber according to some embodiments of the current invention. In FIG. 5A, a high pressure regime 520 can be at or above atmospheric pressure, and the pressure can be reduced to a low pressure regime 510, which can be below atmospheric pressure. The pressure can start at a pressure higher lower than atmospheric pressure (e.g., in process regime 520) and reduce to a lower pressure value, to below atmospheric pressure (e.g., in process regime 510). FIG. 5B shows another process example, in which the high pressure regime 520 can be at or above atmospheric pressure, and the pressure can be reduced to lower the process chamber to a low pressure regime 515, which can at or around atmospheric pressure. The pressure can start at above atmospheric pressure or at atmospheric pressure (e.g., in process regime 520), and reduce to a lower pressure value, to atmospheric pressure or pressures lower than atmospheric pressure (e.g., in process regime 510 or 515).

FIG. 5C shows an example of a process chamber during the pressure reduction. An object 550 is submerged (or partially submerged) in a liquid 545 in a process chamber. The liquid 545 can have a vapor portion 540 on the top surface of the liquid portion 545. The pressure 580 is low, as shown by the pressure monitor. Gases 525 can escape, e.g., by releasing to atmosphere or by a vacuum pump, from the process chamber, lowering the pressure at the vapor portion 540. Bubbles can be generated, for example, bubbles 560 at the object surface, or bubbles 562 in the liquid portion 445. The generated bubbles can be terminated during the next phase of pressure increase, for example, to clean the object.

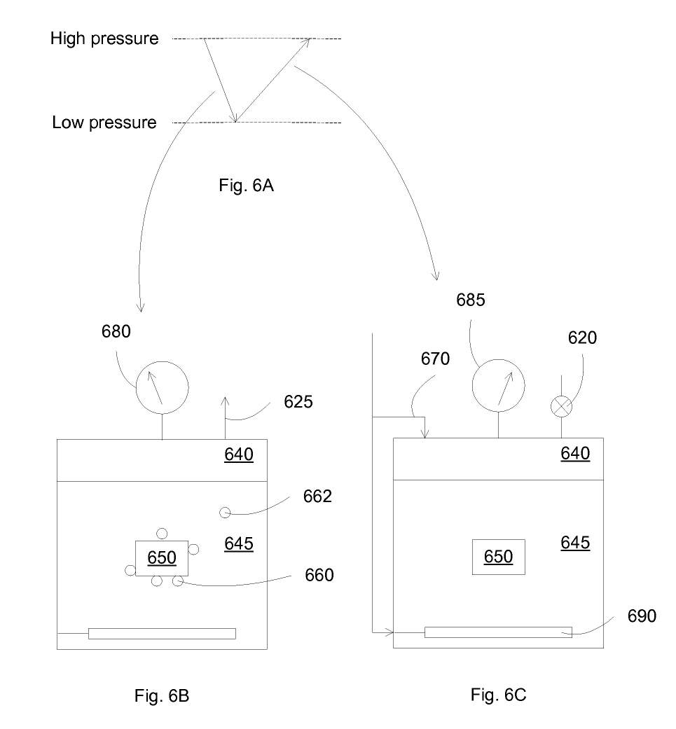

FIGS. 6A-6C illustrate an example of a cyclic nucleation process according to some embodiments of the current invention. In FIG. 6A, a pressure cycle is shown, in which pressure is reduced to generate bubbles, and then increased to terminate the bubbles. The high pressure can be at atmospheric pressure or above atmospheric pressure. The low pressure can be below atmospheric pressure (corresponded to the high pressure at atmospheric pressure) or at atmospheric pressure (corresponded to the high pressure at above atmospheric pressure). Other configurations can be used, as long as the high pressure is higher than the low pressure, such as both high and low pressure are at below atmospheric pressure. In FIG. 6B, an object 650 is submerged (or partially submerged) in a liquid 645 in a process chamber. The liquid 645 can have a vapor portion 640 on the top surface of the liquid portion 645. The pressure 680 is low, as shown by the pressure monitor. Gases 625 can escape, e.g., by releasing to atmosphere or by a vacuum pump, from the process chamber, lowering the pressure at the vapor portion 640. Bubbles can be generated, for example, bubbles 660 at the object surface, or bubbles 662 in the liquid portion 645. The generated bubbles can be terminated during the next phase of pressure increase, for example, to clean the object.

In FIG. 6C, valve 620 can be close, and gases 670 can flow to the process chamber, at the vapor portion 640 and at the liquid portion 645, for example, through a porous element 690 for better distribution. The bubbles 660 and 662 can be terminated due to the high pressure in the vapor portion 640. In addition, gases 670 can introduce bubbles, which can be dissolved to the liquid, for example, from the vapor portion 640 entering the liquid portion 645, or from the porous element 690 entering the liquid portion 645. The pressure 685 is high, as shown by the pressure monitor. The vapor portion can be filled with gases, and the liquid portion can have gases dissolved within. The pressure in the vapor portion 640 can be the same as before the pressure reduction.

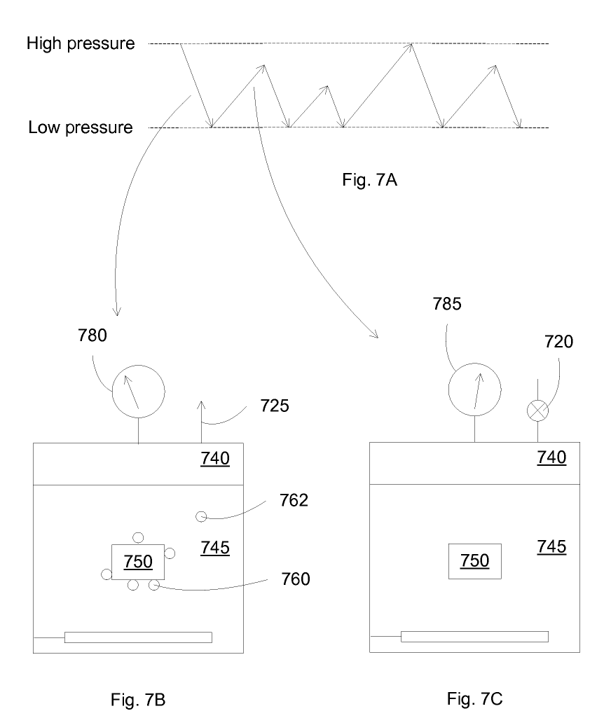

FIGS. 7A-7C illustrate another example of a cyclic nucleation process according to some embodiments of the current invention. In FIG. 7A, a pressure cycle is shown, in which pressure is reduced to generate bubbles, and then increased to terminate the bubbles. Many pressure cycles can be performed before the pressure can return to the original pressure value. In FIG. 7B, an object 750 is submerged (or partially submerged) in a liquid 745 in a process chamber. The liquid 745 can have a vapor portion 740 on the top surface of the liquid portion 745. The pressure 780 is low, as shown by the pressure monitor. Gases 725 can escape, e.g., by releasing to atmosphere or by a vacuum pump, from the process chamber, lowering the pressure at the vapor portion 740. Bubbles can be generated, for example, bubbles 760 at the object surface, or bubbles 762 in the liquid portion 745. The generated bubbles can be terminated during the next phase of pressure increase, for example, to clean the object.

In FIG. 7C, valve 720 can be close. Dissolved gases in the liquid portion 745 can be release to the vapor portion 740 to increase the pressure in the vapor portion. The pressure 785 is high, but not as high as the original pressure value, as shown by the pressure monitor. The bubbles 760 and 762 can be terminated due to the high pressure in the vapor portion 740.

After a number of pressure cycles, gases can introduce bubbles, which can be dissolved to the liquid, for example, from the vapor portion entering the liquid portion, or from the porous element entering the liquid portion. The vapor portion can be filled with gases, and the liquid portion can have gases dissolved within. The pressure in the vapor portion can be increased to the same pressure as before the pressure reduction. The pressure cycle can be continued.

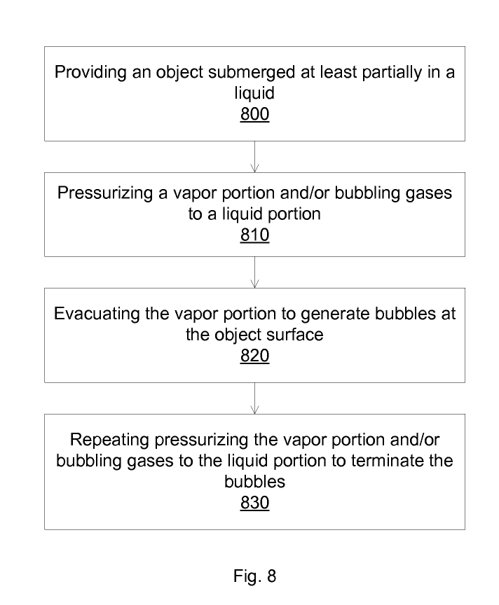

FIG. 8 illustrates another flowchart example of CNX using dissolved gases according to some embodiments of the current invention. In operation 800, an object is submerged at least partially in a liquid in a process chamber. The object can be submerged partially or fully in the liquid. In operation 810, a gas portion of the process chamber can be pressurized, or bubbles can be introduced to the liquid portion of the process chamber. Gases are then dissolved to the liquid. The gases can be provided from a pressurized cylinder. The gases can provide atmospheric pressure or above atmospheric pressure to the vapor portion. In operation 820, the gas in the vapor portion is evacuated to generate bubbles in the liquid, especially at the object surface. For example, the gases can be evacuated by an aspirator or a vacuum pump. The gases can be released to atmosphere by opening a release valve, if the vapor portion is pressurized to above atmospheric pressure.

In operation 850, pressure can be repeatedly applied to the vapor portion of the liquid, for example, by flowing gases to the vapor and/or liquid portions of the liquid. The process can be continued until the object is cleaned.

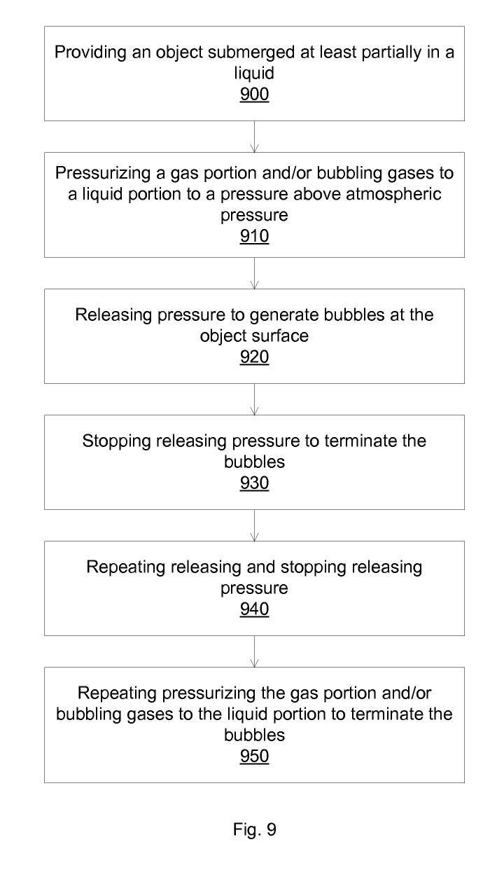

FIG. 9 illustrates a flowchart example of CNX using dissolved gases according to some embodiments of the current invention. In operation 900, an object is submerged at least partially in a liquid. The object can be submerged partially or fully in the liquid. In operation 910, gases are dissolved to the liquid. The gases can be delivered to the vapor portion above the liquid. The gases can be delivered to the liquid portion, bubbling through the liquid. The gases can be delivered to both gas and liquid portions. The gases can be provided from a pressurized cylinder. The gases can provide atmospheric pressure or above atmospheric pressure to the vapor portion. In operation 920, the pressure in the vapor portion is released to generate bubbles in the liquid, especially at the object surface. For example, the gases can be evacuated by an aspirator or a vacuum pump. The gases can be released to atmosphere by opening a release valve, if the vapor portion is pressurized to above atmospheric pressure.

In operation 930, the pressure release is stopped, for example, by closing the release valve. After reaching a certain pressure, the bubbles can be terminated. In operation 940, the pressure release and pressurizing can be repeated to cyclically generating and terminating bubbles. For example, if the vapor portion is pressurized to above atmospheric pressure, the pressure cycling can be performed many times until the pressure reaches atmospheric pressure.

In operation 950, the pressure can be repeatedly increased or reduced, for example, by flowing gases to the vapor and/or liquid portions of the liquid. The process can be continued until the object is cleaned.

In some embodiments, the current invention discloses methods and systems for forming a temperature gradient for a liquid ambient, which can differentially generate bubbles for the object surface. The bubbles generated at the surface can assist in cleaning the object, while the bubbles generated in the liquid away from the object can have minimal effect on the object cleaning process.

In some embodiments, the current invention discloses heating the object to form a temperature gradient. In some embodiments, the current invention discloses cooling the liquid that surrounds the object to form a temperature gradient. In some embodiments, the current invention discloses heating the object together with cooling the liquid surrounding the object to form a temperature gradient. At higher temperatures, bubbles can be formed easier than at lower temperatures, thus a temperature gradient can focus the bubble generation at or near the object surface.

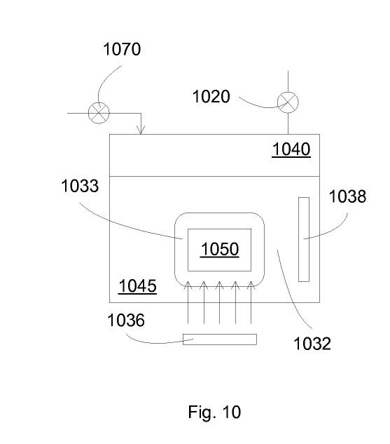

FIG. 10 illustrates an example configuration of a process chamber having temperature gradient according to some embodiments of the current invention. An object 1050 can be submerged in a liquid portion 1045 in a process chamber, with a vapor portion 1040 above the liquid portion. Gas conduits can be coupled to the process chamber, for example, through a valve 1070 for delivering gases to the chamber, or through valve 1020 for release pressure from the process chamber. A cooling mechanism 1038 can be disposed in the liquid portion 1045 for cooling the liquid. A heater mechanism, such as an infrared heater 1036, can be positioned outside the process chamber for heating the object. The heating of the object can generate a thermal gradient, forming a hotter area 1033 surrounding the object, as compared to the liquid 1032 away from the object. The hotter environment can help accelerate the bubble formation near or at the object surface.

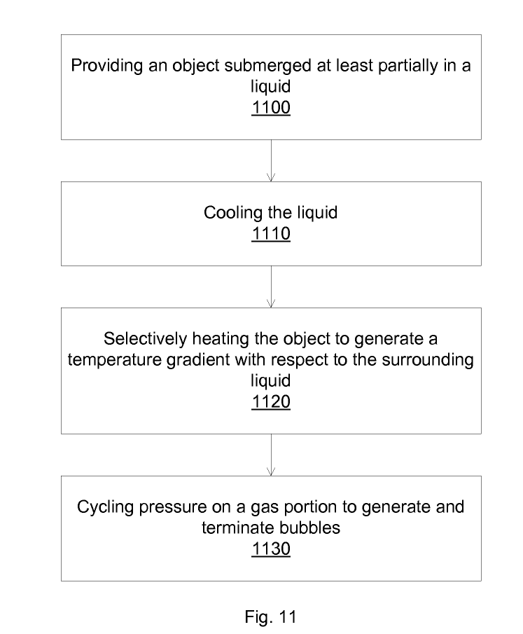

FIG. 11 illustrates a flowchart example of CNX using temperature gradient according to some embodiments of the current invention. In operation 1100, an object is submerged at least partially in a liquid. The object can be submerged partially or fully in the liquid. In operation 1110, the liquid is cooled, for example, by applying a cooling mechanism to the liquid, such as a circulating coolant. In operation 1120, the object is selectively heated. The selective heating of the object can generate a temperature gradient, with the liquid surrounding the object is hotter than the liquid at a distance away from the object. The cooling effect of the cooling mechanism can further re-enforce the temperature gradient, cooling the liquid at a distance away from the object. In operation 1130, the pressure is cyclically varied, for example, increasing and decreasing, to terminate and generate bubbles. Due to the temperature gradient, more bubbles can be formed on or near the object surface than in the liquid away from the object.

In some embodiments, a dynamic chamber process, which comprises a dynamic chamber volume that can instantly change pressure conditions, can be used with the dissolved gases. For example, a process fluid filled chamber can be equipped with a mechanical mechanism which can rapidly change the volume of the chamber. The chamber can be designed to be filled with process fluid, and can withstand pressure changes from vacuum to 2 or more atmospheres.

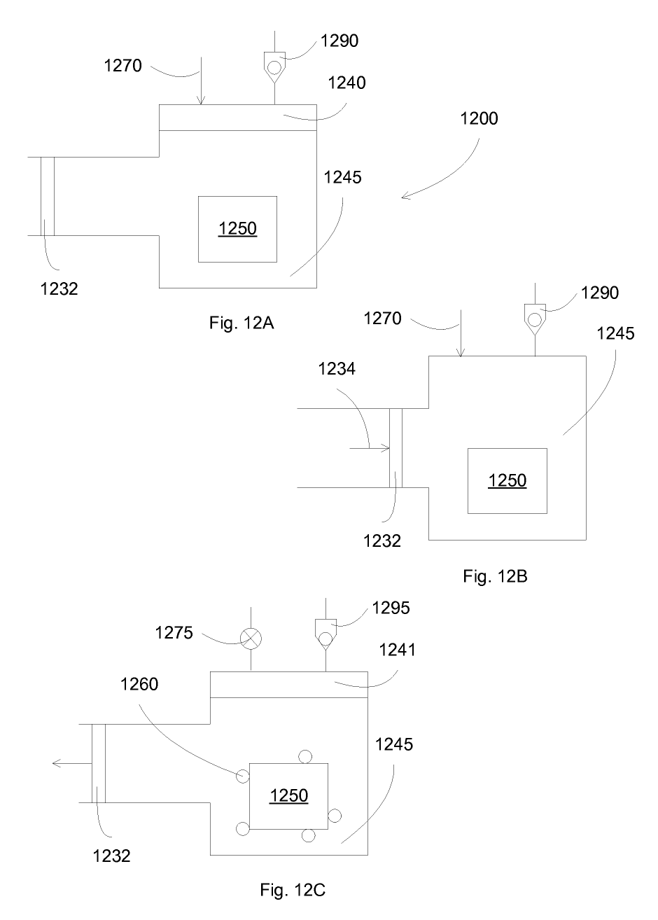

FIGS. 12A-12C illustrate an example of a dynamic chamber operation according to some embodiments of the current invention. In FIG. 12A, a dynamic chamber 1200 including a moveable wall 1232 is partially filled with a liquid 1245, leaving a vapor portion 1240. An object 1250 can be partially or totally submerged in the liquid. A gas flow 1270 can be introduced to pressurize the vapor portion 1240, together with providing bubbles which can be dissolved in the liquid portion 1245. A check valve 1290 can be included to regulate the pressure of the vapor portion. Under the pressurized gas flow 1270, some bubbles of non-vapor gas can be dissolved in the liquid. In FIG. 12B, the moveable wall 1232 is compressed, pushing the vapor portion. The gases in the vapor portion 1240 can further be dissolved in the liquid portion 1245. The liquid can be saturated with the dissolved gases, and remaining gases can be released through the check valve 1290. Gas flow 1270 can continue to flow or can be shut off. In FIG. 12C, valve 1275 is closed, shutting off the gas flow 1270. The moveable wall 1232 can move to enlarge the volume of the chamber, generating vacuum head space 1241. Check valve can be closed 1295. Bubbles 1260 can be generated, for example, at the object surface.

The cycle can be repeated, with gas flow 1270 introduced to the head space 1241, creating a vapor portion above the liquid portion 1245. The bubbles can be terminated, due to the pressure in the vapor portion 1240.

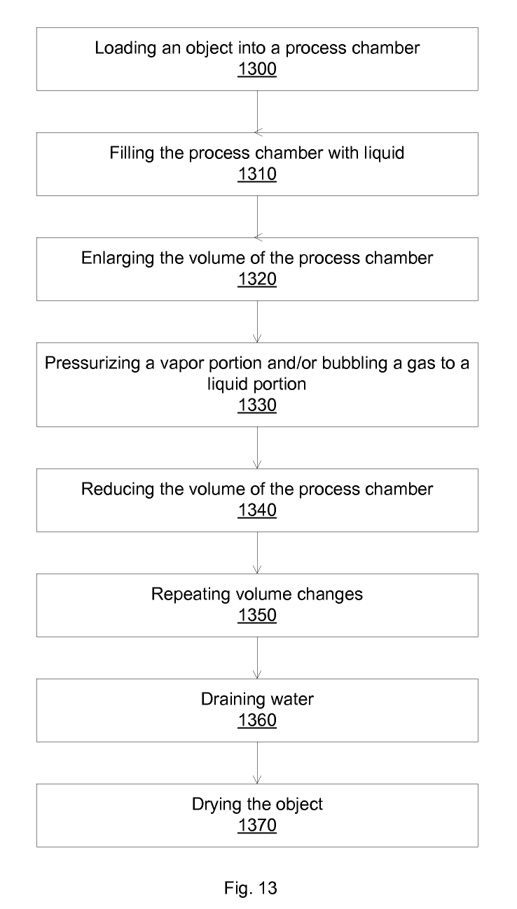

FIG. 13 illustrates a flowchart example of CNX using dynamic chamber according to some embodiments of the current invention. In operation 1300, an object can be loaded into a process chamber. Operation 1310 fills the process chamber with liquid. Operation 1320 enlarges the volume of the process chamber. Operation 1330 pressurizes a vapor portion and/or bubbles a gas to a liquid portion of the process chamber. Operation 1340 reduces the volume of the process chamber. Steps 1320 to 1340 can be executed in any order, such as enlarging before reducing or reducing before enlarging. Operation 1350 repeats the steps of volume enlarging and reducing for nucleation cleaning Operation 1360 drains water. Operation 1370 dries the object, for example, by introducing superheated steam and then venting the steam. The steam can be re-introduced and re-vent for further drying the object.

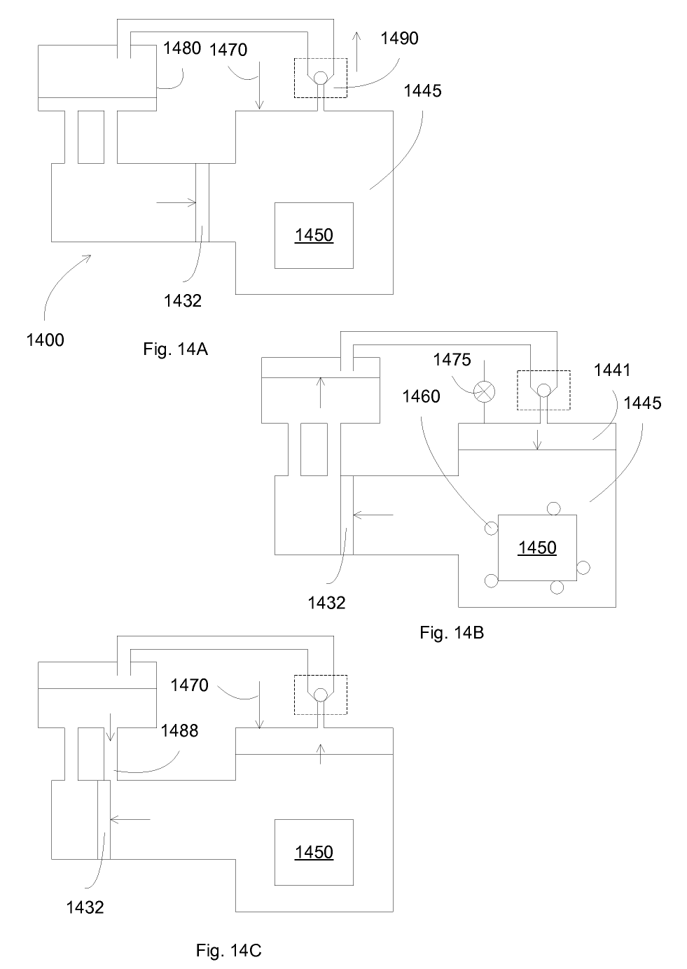

FIGS. 14A-14C illustrate another example of a dynamic chamber operation according to some embodiments of the current invention. In FIG. 14A, a dynamic chamber 1400 including a moveable wall 1432 is partially filled with a liquid 1445. An object 1450 can be partially or totally submerged in the liquid. A gas flow 1470 can be introduced to provide bubbles which can be dissolved in the liquid portion 1445. A check valve 1490 can be included to regulate the pressure of the vapor portion. A reservoir 1480 can provide liquid to a backside of the moveable wall 1432, equalizing pressure for the moveable wall. The moveable wall 1432 is compressed, pushing the liquid portion. The gases can be dissolved in the liquid portion 1445. The liquid can be saturated with the dissolved gases, and remaining gases can be released through the check valve 1490. Gas flow 1470 can continue to flow or can be shut off.

In FIG. 14B, valve 1475 is closed, shutting off the gas flow 1470. The moveable wall 1432 can move to enlarge the volume of the chamber, generating vacuum head space 1441. Check valve can be closed. Bubbles 1460 can be generated, for example, at the object surface. Liquid in the reservoir can rise, due to the movement of the moveable wall. In FIG. 14C, the moveable wall continues to move, opening an opening for liquid in the reservoir to enter the dynamic chamber. Gas flow 1470 can flow to the head space, pressurizing the head space. Under the pressurized gas flow 1470, some bubbles of non-vapor gas can be dissolved in the liquid.

The cycle can be repeated, with gas flow 1470 introduced to the head space 1441, creating a vapor portion above the liquid portion 1445. The bubbles can be terminated, due to the pressure in the vapor portion 1440.

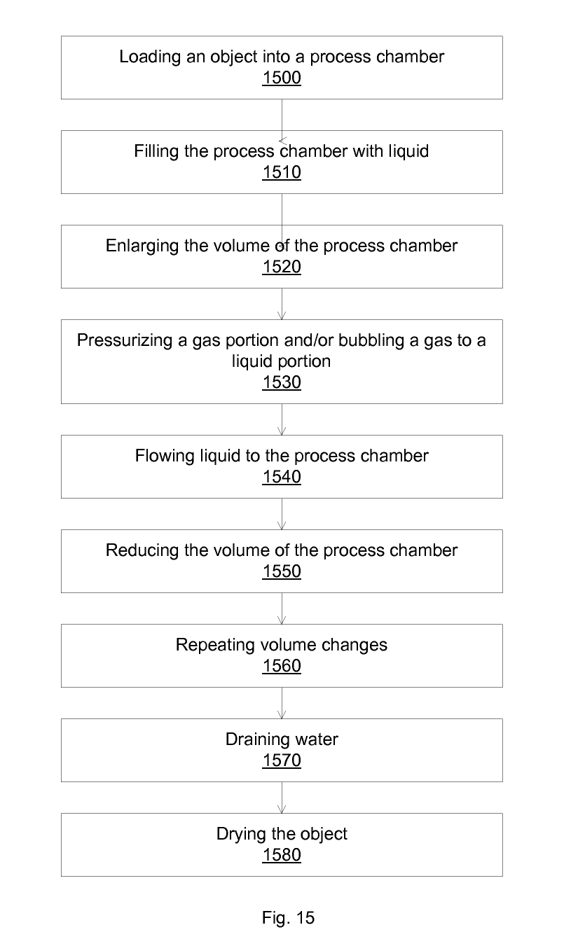

FIG. 15 illustrates a flowchart example of CNX using dynamic chamber according to some embodiments of the current invention. In operation 1500, an object can be loaded into a process chamber. Operation 1510 fills the process chamber with liquid. Operation 1520 enlarges the volume of the process chamber. Operation 1530 pressurizes a vapor portion and/or bubbles a gas to a liquid portion of the process chamber. Operation 1540 flows a liquid to the process chamber. Operation 1550 reduces the volume of the process chamber. Operation 1560 repeats the steps of volume enlarging and reducing for nucleation cleaning Operation 1570 drains water. Operation 1580 dries the object, for example, by introducing superheated steam and then venting the steam. The steam can be re-introduced and re-vent for further drying the object.

In some embodiments, provided are methods and systems to clean an object in a liquid, including cyclically dissolving gas in the liquid and releasing the dissolved gas from the liquid in the form of bubbles. The release of bubbles can be effective in cleaning the surface of the object, especially in hard to reach places. The gas dissolving process can assist in reducing the power required to generate bubbles for object cleaning. The gas dissolving process can include flowing a gas, either to the liquid or to a vapor portion of the liquid.

In some embodiments, the methods can include providing a chamber containing a liquid. The chamber can be configured to be sealed, e.g., isolated from the outside ambient. The isolation can be used to pressurize the chamber or to put the chamber in a sub-atmospheric pressure. The liquid can totally or partially fill the chamber, for example, forming a vapor portion and a liquid portion in the chamber. The liquid can include water or solvent for cleaning, or can include a chemical for processing the object, such as etching. The liquid can include additional chemical agents, such as a surfactant for wetting the object, a cleaning agent for cleaning the object, or other additives such as a catalyst for increasing a solubility of a gas in the liquid.

An object can be submerged in the liquid, either totally submerged or partially submerged. The liquid and the object can be placed in the chamber at a same time, or sequentially one after the other. For example, the object can be introduced to the liquid already existed in the chamber. The object can be placed in the chamber and then the liquid can be added to chamber.

A gas can be introduced to the chamber, which can increase the pressure of the chamber. The gas can be delivered from a pressurized gas source, such as a compressed gas cylinder, from a pressurized cylinder, or from an equipment that can deliver pressurized gas, such as a compressor. With the gas flowing to the chamber, a portion of the gas can be dissolved in the liquid. In addition, the pressure of the chamber, e.g., the vapor pressure of the vapor portion in the chamber, can inhibit the formation of bubbles, e.g., increasing the boiling temperature of the liquid, including terminating any existing bubbles in the liquid.

In some embodiments, the gas can flow to a vapor portion in the chamber or to a liquid portion in the chamber. For example, the gas can flow to the liquid through a porous element to accelerate a gaseous absorption in the liquid. A portion of the flowed gas can be dissolved in the liquid. In some embodiments, the gas and the liquid can be selected to have a high solubility of gas in the liquid. For example, the ratio of the concentration of the gas in the liquid and the concentration of the gas in the vapor portion of the liquid can be greater than 1 percent. The gas can include CO₂, NH₃, SO₂, H₂S, O₂, N₂, He, or any combination thereof.

After the chamber pressure reaches a setpoint, such as a predetermined pressure or a predetermined solubility of the gas in the liquid, the gas flow can stop. The gas can flow to the chamber to reach a chamber pressure of atmospheric pressure or higher. The gas can flow to the chamber to reach a chamber pressure of higher than 2 or 5 atmospheric pressure. The high pressure in the chamber generated from the gas flow can terminate a formation of bubbles in the liquid.

A portion of the gas, for example, in the vapor portion of the chamber, can be removed, which can reduce the pressure in the chamber. When the chamber pressure is lowered to a certain pressure, bubbles can form, for example, from the dissolved gas in the liquid. The bubbles can form at the surface of the object or can form in the liquid. The bubbles can escape or release from the liquid to the vapor portion, and can clean or etch the object.

In some embodiments, the gas can be removed by evacuating the gas from a vapor portion of the chamber, for example, by a vacuum assembly such as a vacuum pump. The gas can be removed by releasing the gas from a vapor portion of the chamber to an outside ambient, for example, by connecting the chamber pressure with the outside ambient having a lower pressure than the chamber pressure. The chamber pressure can be higher than the atmospheric pressure, and thus when connecting the chamber to the outside ambient, which is at atmospheric pressure, the pressure can be released.

In some embodiments, the pressure can be released repeatedly. For example, if the chamber pressure is higher than the ambient atmospheric pressure, a connecting valve can be repeatedly open and close. The opening of the valve can release and thus reduce the chamber pressure. After the valve is close, if the chamber pressure is still above atmospheric pressure, the valve can be re-open for continuing reducing pressure.

The process can be repeated, e.g., gas can be introduced to the chamber and then removed from the chamber. During the flow of gas, the chamber pressure can increase and terminate or release the bubbles, further assist in cleaning or etching the object. During the removal of gas, the bubbles can form and then be removed for object cleaning.

In some embodiments, the object can be selectively heated, e.g., the object can be heated so that the object temperature can be higher than the temperature of the surrounding ambient, e.g., liquid. The high temperature of the object can promote bubble generation at the surface of the object, which can assist in cleaning the object. The lower temperature of the liquid can reduce the amount of bubble generation in the liquid, since the bubbles in the liquid does not significantly effect the object cleanliness.

In some embodiments, gases can be produced as a by-product in a chemical reaction between chemicals in the liquid and material at the surface of a part being processed. For example, in a silicon etch process, KOH can react with silicon surface of parts having silicon material to generate a gaseous byproduct. Or H₂O₂ can react with bio-matter contamination on the surface of a part to be cleaned to generate a gaseous byproduct. Alternatively, gases can be produced in a chemical reaction between different chemicals contained in the liquid. For example, a piranha solution, i.e., a mixture of sulfuric acid and hydrogen peroxide, can produce gases byproducts due to the reaction of sulfuric acid with hydrogen peroxide.

In some embodiments, a vacuum pump can be used to reduce pressures to sub-atmospheric which can lead to vapor bubble nucleation as well as the expansion and displacement of gaseous byproduct bubbles and/or the release of gaseous byproducts into expanding bubbles. Vacuum cyclic nucleation can be suitable for delicate parts and temperature-limited applications.

In some embodiments, a hyperbaric chamber can be used, in which the liquid and gaseous byproducts are under pressures higher that atmospheric pressure. Pressure reduction cycles can be accomplished by releasing pressure through a control valve to atmospheric pressure. Since hyperbaric cyclic nucleation works in hyperbaric pressure range, there can be a greater drop in pressure than is possible with a vacuum system. This is because a vacuum system only has a pressure range from zero to 1 atmosphere whereas a hyperbaric system operates in a much greater pressure range from 1 to 16 atmospheres or more. Hence hyperbaric cyclic nucleation may provide a more powerful cleaning process. In addition, in some embodiments, high pressure can be used to suppress the reaction between two liquids.

In some embodiments, dynamic chamber cyclic nucleation technology can be used, in which pressure is cycled to produce cyclic nucleation transport and gas expansion displacement. The volume of a process chamber can be directly cycled to produce the instantaneous pressure changes that produce cyclic nucleation transport and gas expansion displacement.

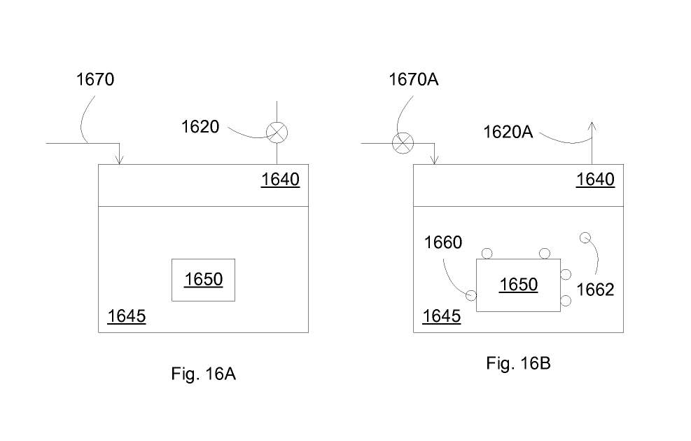

FIGS. 16A-16B illustrate an example of CNX using a gaseous reaction between a liquid and the object to be cleaned according to some embodiments of the current invention. In FIG. 16A, an object 1650 is submerged in a liquid 1645 in a process chamber. As shown, the object is fully submerged. Other configurations can also be used, such as an object partially submerged in the liquid. A vapor portion 1640 can be present above the liquid portion 1645. The vapor portion 1640 can include a release valve 1620, which is closed. A gas 1670 can be provided to the vapor portion 1640, pressurizing the vapor portion. The gas 1670 can be coupled to a pressurized cylinder, which can flow to the process chamber. The gas 1670 can be any gases, such as air, CO₂, N₂, O₂, etc. The liquid can be any liquid that can react with the object, or anything attached to the object, such as organic contaminants. For example, KOH can be used for silicon containing object, where KOH can react with silicon to generate a gaseous byproduct. Or objects having organic contaminants can be placed in H₂O₂ liquid, and the reaction can generate a gaseous byproduct. Valve 1620 is close, and the pressure in the vapor portion 1640 is high, partially or fully stopping the reaction of the liquid with the object.

In FIG. 16B, the gas delivery is stopped, for example, by closing valve 1670A, after reaching a desired pressure. For example, the desired pressure can be such that any bubbles in the liquid can be suppressed or terminated. The pressure can be at atmospheric or at higher than atmospheric pressure, e.g., 10-25 atm. Release valve 1620 is open, and byproduct gases 1620A can escape from the process chamber. For example, a vacuum pump can be coupled to the release valve 1620, and gases can be evacuated through the pumping action. Alternatively, the release valve 1620 can be open to atmosphere, and higher than atmospheric pressure within the process chamber can be reduced to atmospheric pressure through gas flow 1620A. With lower pressure in the vapor portion 1640, bubbles 1660 and 1662, which are the byproduct of the reaction of the liquid 1645 with the object 1650, can be formed in the liquid 1645.

The process can be repeated. For example, release valve 1620 is close, and gas 1670 can be delivered to the process chamber. The gas flow 1670 can pressurize the vapor portion 1640, effectively terminating the bubbles 1660 and 1662. The process then continues, generating the bubbles at the object surface, terminating the bubbles, and re-generating bubbles to the liquid. The cyclic generating and terminating bubbles at the object surface can clean the object, especially at hard to reach surfaces. In addition, the reaction can also etch the object, furthering the cleaning process. In some embodiments, the liquid can be replenished, for example, by adding new liquid to the process chamber. Alternatively, used liquid can be drained, and new liquid added.

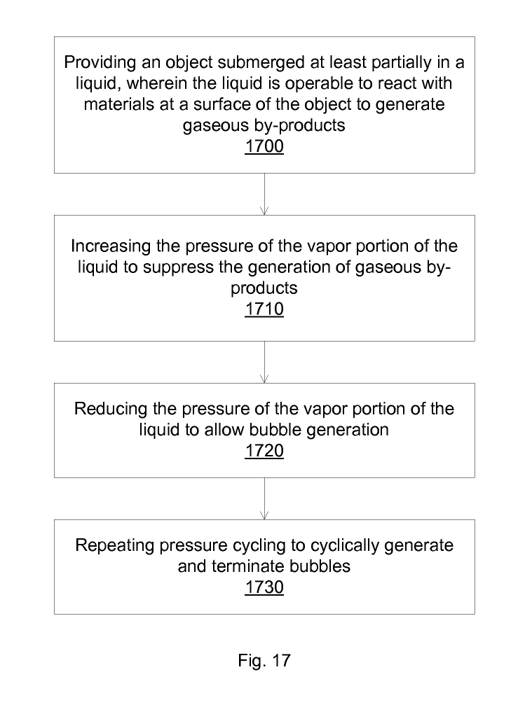

FIG. 17 illustrates a flowchart example of CNX using a gaseous reaction between a liquid and the object to be cleaned according to some embodiments of the current invention. In operation 1700, an object is submerged at least partially in a liquid. The object can be submerged partially or fully in the liquid. The liquid is selected to react with the material with the object, such as an etching reaction. The liquid can also be selected to react with a contaminant that adheres to the object, such as organic contaminants. In operation 1710, the pressure in the vapor portion is increased to suppress the reaction of the liquid, which terminates any gaseous byproduct. The vapor portion can be pressurized, for example, by closing a release valve or by flowing a gas to the process chamber. After reaching a certain pressure, the bubbles can be terminated. In operation 1720, the pressure is reduced to allow bubble formation, for example, as the gaseous byproducts of the reaction of the liquid. For example, the gases can be evacuated by an aspirator or a vacuum pump. The gases can be released to atmosphere by opening a release valve, if the vapor portion is pressurized to above atmospheric pressure. In operation 1730, the pressure release and pressurizing can be repeated to cyclically generating and terminating bubbles. For example, if the vapor portion is pressurized to above atmospheric pressure, the pressure cycling can be performed many times until the pressure reaches atmospheric pressure. The process can be continued until the object is cleaned. Optionally, new liquid can be added.

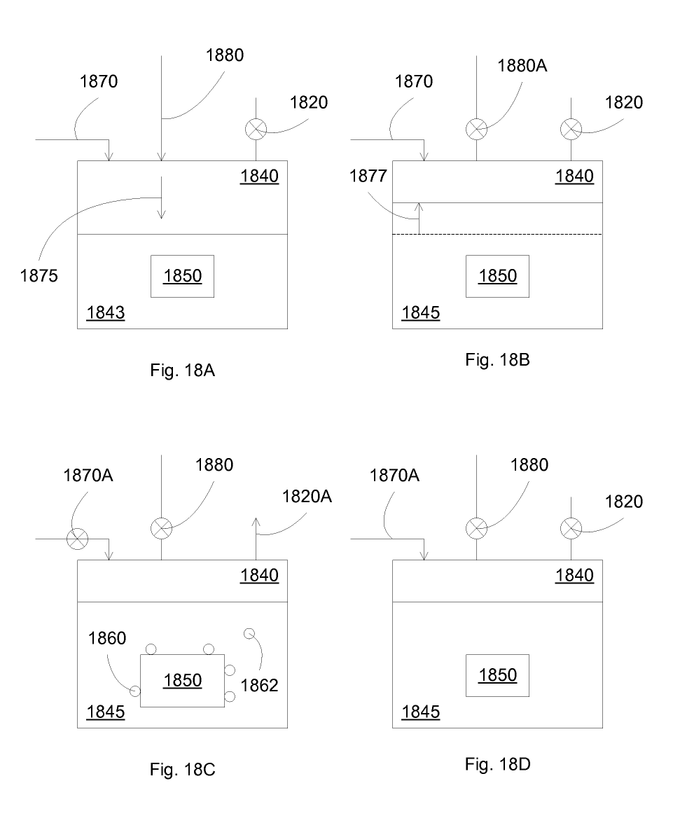

FIGS. 18A-18D illustrate an example of CNX using a gaseous reaction between two different liquids according to some embodiments of the current invention. In FIG. 18A, an object 1850 is submerged in a first liquid 1843 in a process chamber. As shown, the object is fully submerged. Other configurations can also be used, such as an object partially submerged in the first liquid. A vapor portion 1840 can be present above the liquid portion 1845. The vapor portion 1840 can include a release valve 1820, which is closed. A gas 1870 can be provided to the vapor portion 1840, pressurizing the vapor portion. The gas 1870 can be coupled to a pressurized cylinder, which can flow to the process chamber. The gas 1870 can be any gases, such as air, CO₂, N₂, O₂, etc. A second liquid 1875 can be introduced to the process chamber, for example, through inlet 1880 to form a mixture 1845. The first and second liquids are selected to react with each other to produce a gaseous byproduct. For example, a second liquid of hydrogen peroxide can be added to a first liquid of acid sulfuric to form a piranha solution. The two liquids can react to produce gases byproducts. Valve 1820 is close, and the pressure in the vapor portion 1840 is high, partially or fully stopping the reaction of the liquids.

In FIG. 18B, the second liquid flow 1875 is stopped, for example, by closing valve 1880A. The liquid mixture 1845 can be increased an amount 1877.

In FIG. 18C, the gas delivery is stopped, for example, by closing valve 1870A, after reaching a desired pressure. For example, the desired pressure can be such that any bubbles in the liquid can be suppressed or terminated. The pressure can be at atmospheric or at higher than atmospheric pressure, e.g., 10-25 atm. Release valve 1820 is open, and byproduct gases 1820A can escape from the process chamber. For example, a vacuum pump can be coupled to the release valve 1820, and gases can be evacuated through the pumping action. Alternatively, the release valve 1820 can be open to atmosphere, and higher than atmospheric pressure within the process chamber can be reduced to atmospheric pressure through gas flow 1820A. With lower pressure in the vapor portion 1840, bubbles 1860 and 1862, which are the byproduct of the reaction of the liquid 1845 with the object 1850, can be formed in the liquid 1845.

In FIG. 18D, the process can be repeated. For example, release valve 1820 is close, and gas 1870 can be delivered to the process chamber. The gas flow 1870 can pressurize the vapor portion 1840, effectively terminating the bubbles 1860 and 1862. The process then continues, generating the bubbles at the object surface, terminating the bubbles, and re-generating bubbles to the liquid. The cyclic generating and terminating bubbles at the object surface can clean the object, especially at hard to reach surfaces. In some embodiments, the first and/or second liquids can be replenished or replaced.

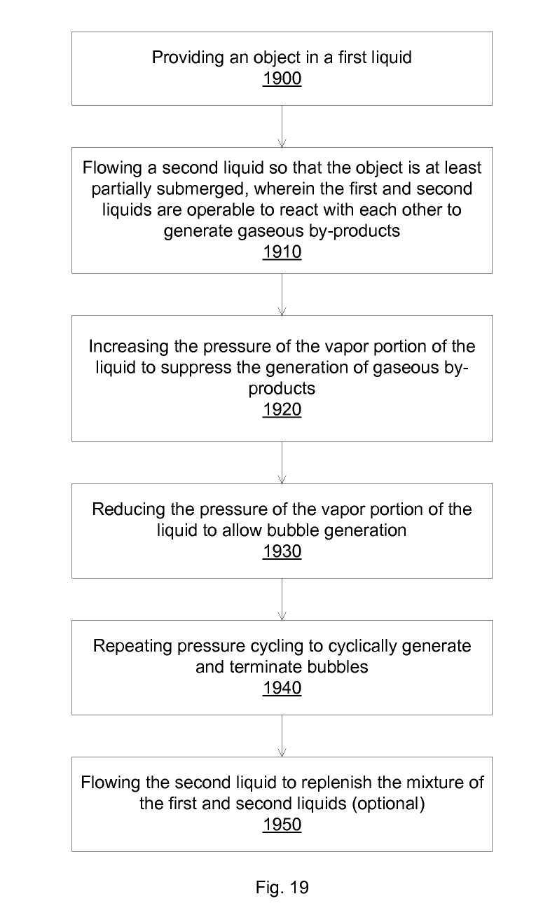

FIG. 19 illustrates another flowchart example of CNX using dissolved gases according to some embodiments of the current invention. In operation 1900, an object is submerged at least partially in a first liquid in a process chamber. The object can be submerged partially or fully in the first liquid. The object can be above the first liquid level. In operation 1910, a second liquid is flowed to the process chamber so that the object is partially or fully submerged. The first liquid and the second liquid are operable to react with each other to generate a gaseous byproduct. In operation 1920, the pressure of the vapor portion in the process chamber is increased to terminate or suppress the reaction between the two liquids, for example, by preventing the formation of bubbles in the process chamber. In operation 1930, the pressure is reduced to promote the reaction, or to generate bubbles in the liquids, especially at the object surface. For example, the gases can be evacuated by an aspirator or a vacuum pump. The gases can be released to atmosphere by opening a release valve, if the vapor portion is pressurized to above atmospheric pressure.

In operation 1940, pressure can be repeatedly applied to the vapor portion of the liquid, for example, by flowing gases to the vapor and/or liquid portions of the liquid. The process can be continued until the object is cleaned. In operation 1950, the second liquid can be optionally added to the process chamber to replenish the mixture of the first and second liquids.

In some embodiments, the current invention discloses methods and systems for forming a temperature gradient for a liquid ambient, which can differentially generate bubbles for the object surface. The bubbles generated at the surface can assist in cleaning the object, while the bubbles generated in the liquid away from the object can have minimal effect on the object cleaning process.

In some embodiments, the current invention discloses heating the object to form a temperature gradient. In some embodiments, the current invention discloses cooling the liquid that surrounds the object to form a temperature gradient. In some embodiments, the current invention discloses heating the object together with cooling the liquid surrounding the object to form a temperature gradient. At higher temperatures, bubbles can be formed easier than at lower temperatures, thus a temperature gradient can focus the bubble generation at or near the object surface.

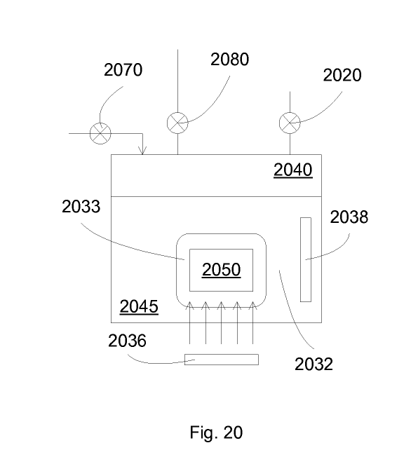

FIG. 20 illustrates an example configuration of a process chamber having temperature gradient according to some embodiments of the current invention. An object 2050 can be submerged in a liquid portion 2045 in a process chamber, with a vapor portion 2040 above the liquid portion. Gas conduits can be coupled to the process chamber, for example, through a valve 2070 for delivering gases to the chamber, or through valve 2020 for release pressure from the process chamber. A valve 2080 can be used to deliver a second liquid to the chamber, which can react with the existing liquid to generate gaseous byproducts. A cooling mechanism 2038 can be disposed in the liquid portion 2045 for cooling the liquid. A heater mechanism, such as an infrared heater 2036, can be positioned outside the process chamber for heating the object. The heating of the object can generate a thermal gradient, forming a hotter area 2033 surrounding the object, as compared to the liquid 2032 away from the object. The hotter environment can help accelerate the bubble formation near or at the object surface.

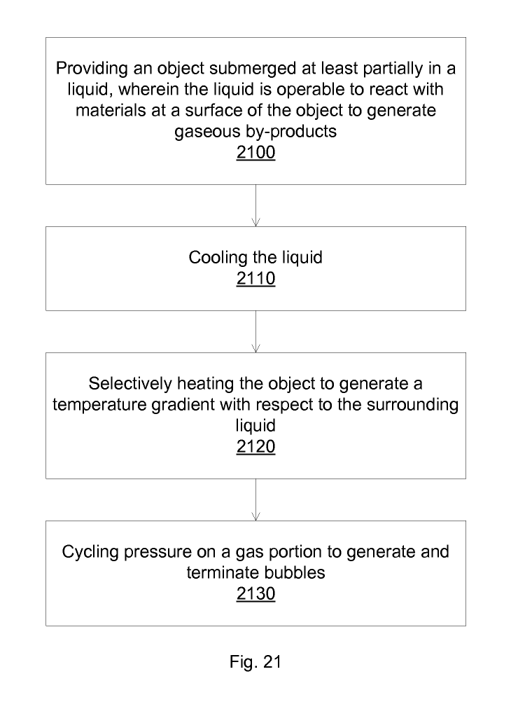

FIG. 21 illustrates a flowchart example of CNX using temperature gradient according to some embodiments of the current invention. In operation 2100, an object is submerged at least partially in a liquid. The liquid is operable to react with the materials at a surface of the object, such as organic contaminants or the object material, to generate gaseous byproducts. The object can be submerged partially or fully in the liquid. In operation 2110, the liquid is cooled, for example, by applying a cooling mechanism to the liquid, such as a circulating coolant. In operation 2120, the object is selectively heated. The selective heating of the object can generate a temperature gradient, with the liquid surrounding the object is hotter than the liquid at a distance away from the object. The cooling effect of the cooling mechanism can further re-enforce the temperature gradient, cooling the liquid at a distance away from the object. In operation 2130, the pressure is cyclically varied, for example, increasing and decreasing, to terminate and generate bubbles. Due to the temperature gradient, more bubbles can be formed on or near the object surface than in the liquid away from the object.

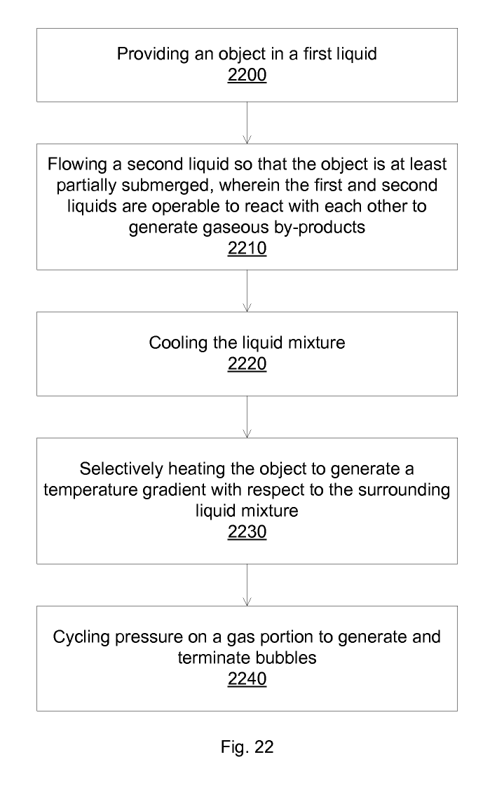

FIG. 22 illustrates another flowchart example of CNX using temperature gradient according to some embodiments of the current invention. In operation 2200, an object provided with a first liquid. The object can be submerged partially in a first liquid. In operation 2210, a second liquid is flowed to the process chamber so that the object is at least partially submerged. The first and second liquids are operable to react with each other to generate gaseous byproducts. In operation 2220, the liquid is cooled, for example, by applying a cooling mechanism to the liquid, such as a circulating coolant. In operation 2230, the object is selectively heated. The selective heating of the object can generate a temperature gradient, with the liquid surrounding the object is hotter than the liquid at a distance away from the object. The cooling effect of the cooling mechanism can further re-enforce the temperature gradient, cooling the liquid at a distance away from the object. In operation 2240, the pressure is cyclically varied, for example, increasing and decreasing, to terminate and generate bubbles. Due to the temperature gradient, more bubbles can be formed on or near the object surface than in the liquid away from the object.

In some embodiments, a dynamic chamber process, which includes a dynamic chamber volume that can instantly change pressure conditions, can be used with the process. For example, a process fluid filled chamber can be equipped with a mechanical mechanism which can rapidly change the volume of the chamber. The chamber can be designed to be filled with process fluid, and can withstand pressure changes from vacuum to 2 or more atmospheres.

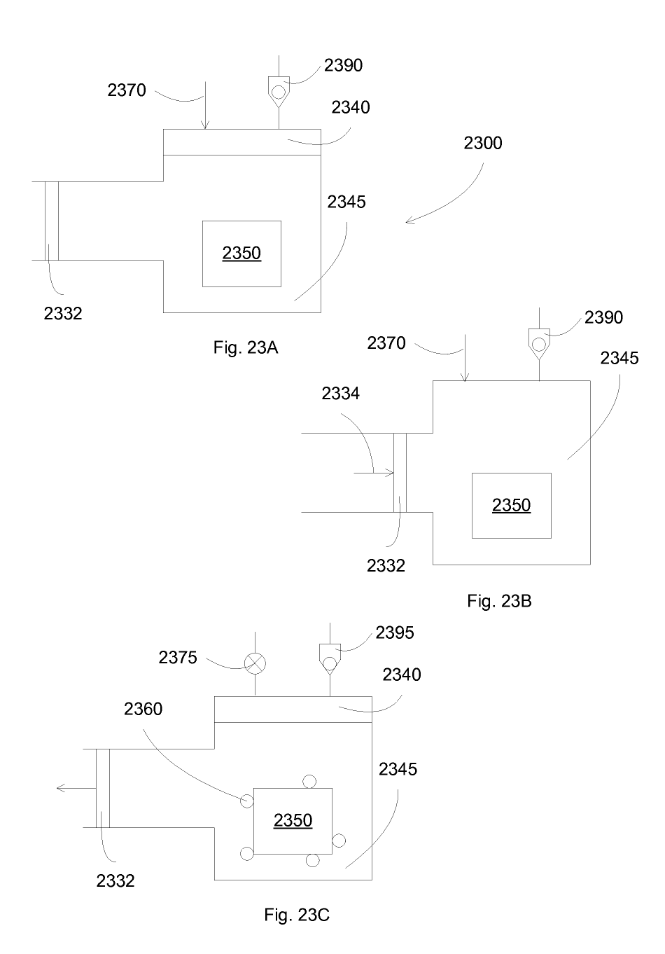

FIGS. 23A-23C illustrate an example of a dynamic chamber operation according to some embodiments of the current invention. In FIG. 23A, a dynamic chamber 2300 including a moveable wall 2332 is partially filled with a first liquid 2345, leaving a vapor portion 2340. An object 2350 can be partially or totally submerged in the liquid. A second liquid flow 2370 can be introduced to the dynamic chamber. The first and second liquids can react with each other to generate gaseous byproducts. A check valve 2390 can be included to regulate the pressure of the vapor portion. Under the second liquid flow 2370, some bubbles of byproducts of the reaction between the first and second liquid can be generated. In FIG. 23B, the moveable wall 2332 is compressed, pushing the vapor portion. The pressure increases and the reaction between the first and second liquids is suppressed. Excess gases can be released through the check valve 2390. Liquid flow 2370 can continue to flow or can be shut off. In FIG. 23C, valve 2375 is closed, shutting off the liquid flow 2370. The moveable wall 2332 can move to enlarge the volume of the chamber, generating vacuum head space 2341. Check valve can be closed 2395. Bubbles 2360 can be generated, for example, at the object surface.

The cycle can be repeated, with occasionally liquid flow 2370 introduced to the chamber, replenishing the consumption of the second liquid due to the reaction with the first liquid in the process chamber. The bubbles can be cyclically generated and terminated, due to the oscillation of pressure in the vapor portion 2340.

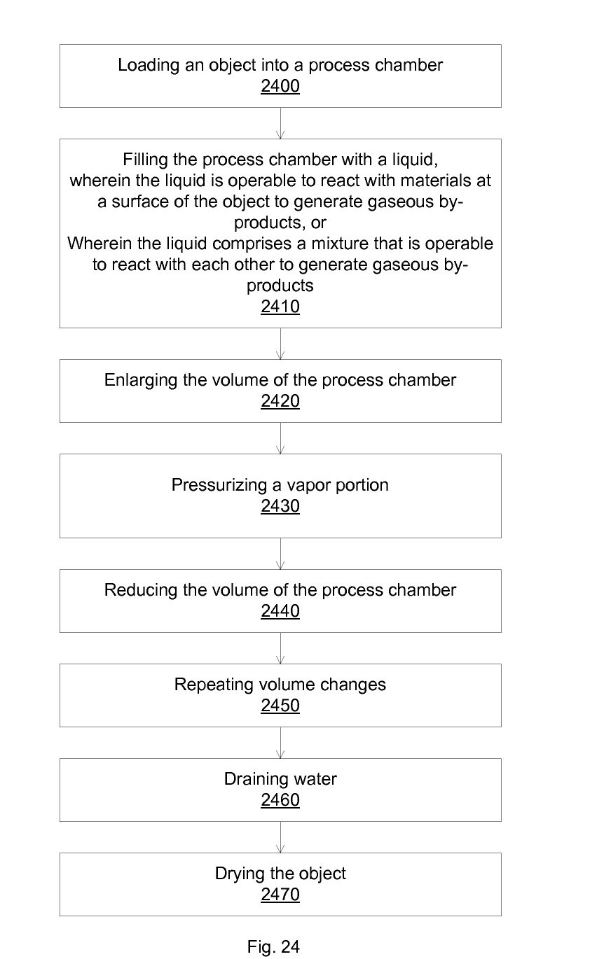

FIG. 24 illustrates a flowchart example of CNX using dynamic chamber according to some embodiments of the current invention. In operation 2400, an object can be loaded into a process chamber. Operation 2410 fills the process chamber with liquid. The liquid can be operable to react with materials at a surface of the object to generate gaseous by-products. The liquid can include a mixture that is operable to react with each other to generate gaseous by-products. The liquid can be introduced as a mixture, or the components of the mixture can be introduced in sequence. Operation 2420 enlarges the volume of the process chamber. Operation 2430 pressurizes a vapor portion and/or bubbles a gas to a liquid portion of the process chamber. Operation 2440 reduces the volume of the process chamber. Steps 2420 to 2440 can be executed in any order, such as enlarging before reducing or reducing before enlarging. Operation 2450 repeats the steps of volume enlarging and reducing for nucleation cleaning Operation 2460 drains water. Operation 2470 dries the object, for example, by introducing superheated steam and then venting the steam. The steam can be re-introduced and re-vent for further drying the object.

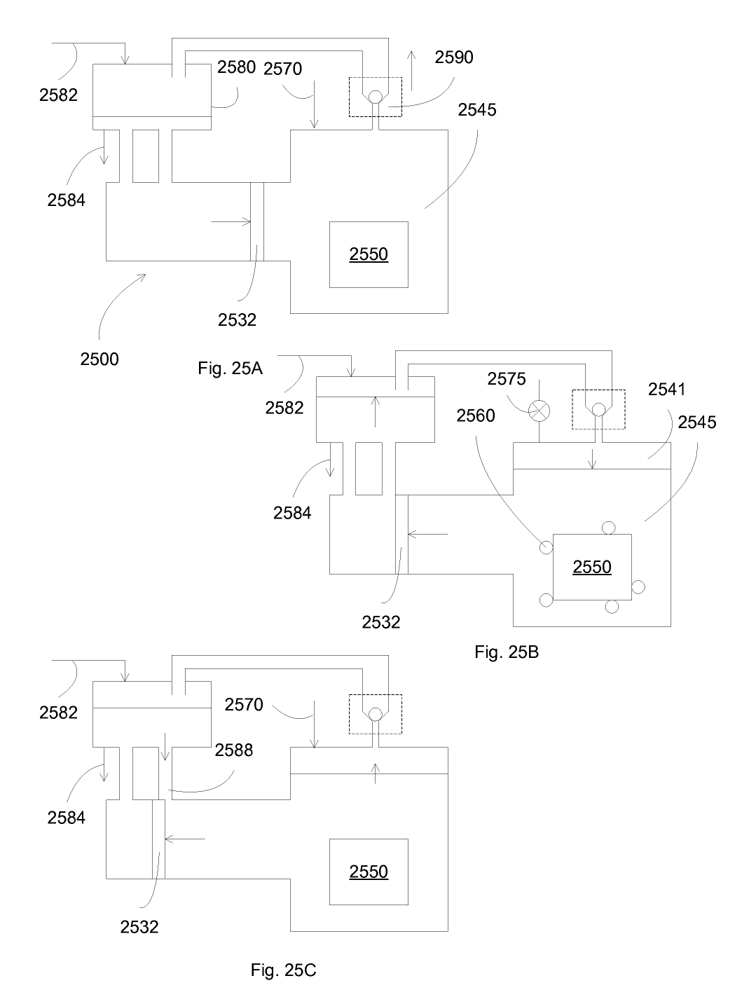

FIGS. 25A-25C illustrate another example of a dynamic chamber operation according to some embodiments of the current invention. In FIG. 25A, a dynamic chamber 2500 including a moveable wall 2532 is partially filled with a liquid 2545. An object 2550 can be partially or totally submerged in the liquid. A gas flow 2570 can be introduced to provide bubbles which can be dissolved in the liquid portion 2545. A check valve 2590 can be included to regulate the pressure of the vapor portion. A reservoir 2580 can provide liquid to a backside of the moveable wall 2532, equalizing pressure for the moveable wall. The moveable wall 2532 is compressed, pushing the liquid portion. Gas flow 2570 can continue to flow or can be shut off. A second liquid flow 2582 can be occasionally introduced to the reservoir 2580. The second liquid can react with the liquid 2545 in the chamber to generate a gaseous byproduct. A drainage 2584 can be used to remove excess liquid from the reservoir 2584.

In FIG. 25B, valve 2575 is closed, shutting off the gas flow 2570. The moveable wall 25032 can move to enlarge the volume of the chamber, generating vacuum head space 2541. Check valve can be closed. Bubbles 2560 can be generated, for example, at the object surface. Liquid in the reservoir can rise, due to the movement of the moveable wall. In FIG. 25C, the moveable wall continues to move, opening an opening for liquid in the reservoir to enter the dynamic chamber. Gas flow 2570 can flow to the head space, pressurizing the head space.

The cycle can be repeated, with gas flow 2570 introduced to the head space 2541, creating a vapor portion above the liquid portion 2545. The bubbles can be cyclically generated and terminated, due to the oscillation of pressure in the vapor portion 2540.

Alternatively, gas flow 2570 can be replaced with the second liquid flow, e.g., liquid flow 2582, so that the second flow can be directly introduced to the chamber. Both gas and liquid flow can share the flow inlet 2570, for example, through a switching valve, permitting a selection of either gas or liquid to be introduced to the chamber.

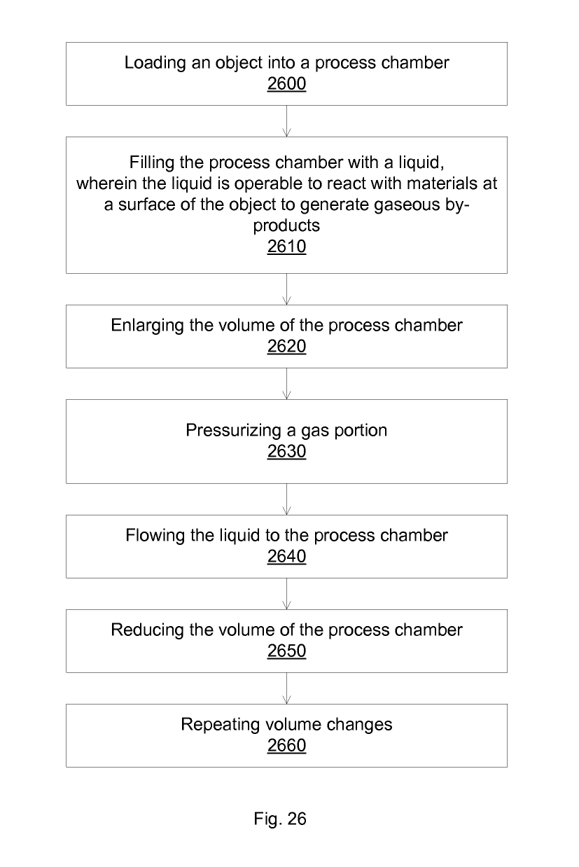

FIG. 26 illustrates a flowchart example of CNX using dynamic chamber according to some embodiments of the current invention. In operation 2600, an object can be loaded into a process chamber. Operation 2610 fills the process chamber with liquid. The liquid is operable to react with materials at a surface of the object to generate gaseous by-products. Operation 2620 enlarges the volume of the process chamber. Operation 2630 pressurizes a vapor portion and/or bubbles a gas to a liquid portion of the process chamber. Operation 2640 flows a liquid to the process chamber. Operation 2650 reduces the volume of the process chamber. Operation 2660 repeats the steps of volume enlarging and reducing for nucleation cleaning. Operation 2670 drains water. Operation 2680 dries the object, for example, by introducing superheated steam and then venting the steam. The steam can be re-introduced and re-vent for further drying the object.

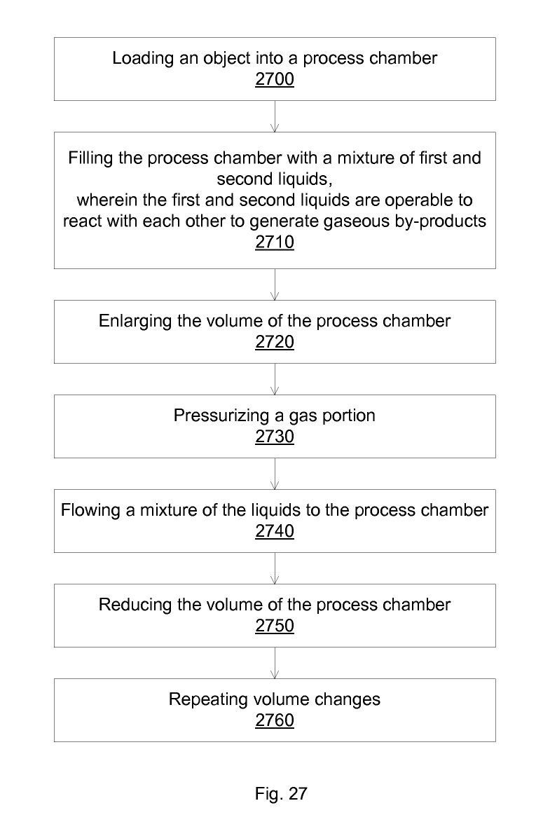

FIG. 27 illustrates another flowchart example of CNX using dynamic chamber according to some embodiments of the current invention. In operation 2700, an object can be loaded into a process chamber. Operation 2710 fills the process chamber with a mixture of first and second liquids. The first and second liquids are operable to react with each other to generate gaseous by-products. Operation 2720 enlarges the volume of the process chamber. Operation 2730 pressurizes a vapor portion and/or bubbles a gas to a liquid portion of the process chamber. Operation 2740 flows a mixture of the first and second liquids to the process chamber. Operation 2750 reduces the volume of the process chamber. Operation 2760 repeats the steps of volume enlarging and reducing for nucleation cleaning Operation 2770 drains water. Operation 2780 dries the object, for example, by introducing superheated steam and then venting the steam. The steam can be re-introduced and re-vent for further drying the object.

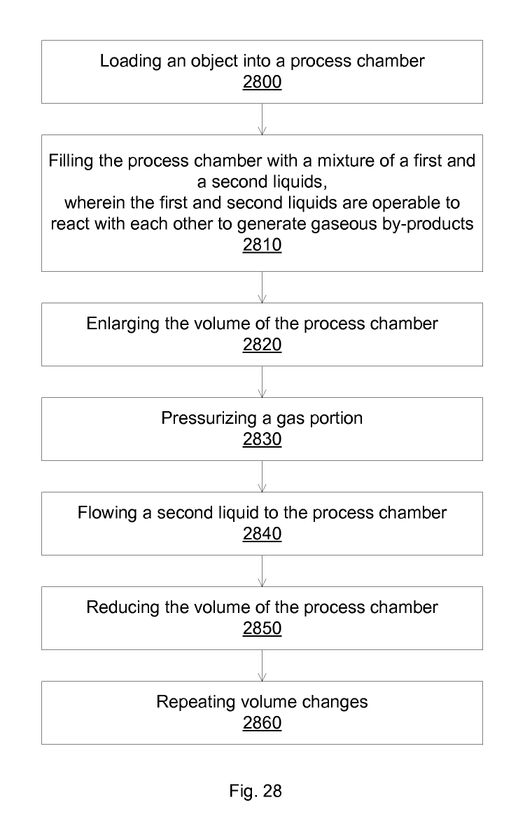

FIG. 28 illustrates another flowchart example of CNX using dynamic chamber according to some embodiments of the current invention. In operation 2800, an object can be loaded into a process chamber. Operation 2810 fills the process chamber with liquid. For example, the liquid can include a mixture of first and second liquids. The first and second liquids are operable to react with each other to generate gaseous by-products. Alternatively, the liquid can include the first liquid. Operation 2820 enlarges the volume of the process chamber. Operation 2830 pressurizes a vapor portion and/or bubbles a gas to a liquid portion of the process chamber. Operation 2840 flows a second liquid to the process chamber. The addition of the second liquid can be occasionally, serving to replenish the consumption of the second liquid due to the reaction with the first liquid. Operation 2850 reduces the volume of the process chamber. Operation 2860 repeats the steps of volume enlarging and reducing for nucleation cleaning Operation 2870 drains water. Operation 2880 dries the object, for example, by introducing superheated steam and then venting the steam. The steam can be re-introduced and re-vent for further drying the object.

In some embodiments, provided are methods and systems to clean an object in a liquid, including cyclically stopping and releasing bubbles that can be formed by a reaction of the liquid with the object. The stopping of bubble formation can control the rate of reaction between the liquid and the object, which can improve the effectiveness of the reaction of the liquid with the object.

In some embodiments, the methods can include providing a chamber containing a liquid. The chamber can be configured to be sealed. The liquid can totally or partially fill the chamber, for example, forming a vapor portion and a liquid portion in the chamber. The liquid can be selected to react with a surface of the object, such as the material of the object in an exposed surface of the object, or adhered contaminants on a surface of the object. Further, the reaction of the liquid with the object surface can generate bubbles, e.g., gaseous component by-products. In some embodiments, the object can include a silicon-containing surface and the liquid can include KOH. The object can include an organic contaminated surface, and the liquid can include hydrogen peroxide.

The object can be submerged in the liquid, either totally submerged or partially submerged. The liquid and the object can be placed in the chamber at a same time, or sequentially one after the other. For example, the object can be introduced to the liquid already existed in the chamber. The object can be placed in the chamber and then the liquid can be added to chamber.

The chamber pressure can increase, for example, by flowing a gas to the chamber. The high pressure can stop or slow the reaction of the liquid with the object, for example, by restricting the formation of the bubbles. Further, the high pressure can terminate any existing bubbles in the liquid.

The chamber pressure can decrease, for example, by removing the gas in the chamber. The low pressure can promote the reaction of the liquid with the object, for example, by allowing the formation of the bubbles. The bubbles can be generated at the object surface, which can be used to clean the object surface.

For example, the liquid can be operated to generate bubbles at atmospheric pressure when contacting the surface of the object. To restrict the reaction, e.g., prohibiting the bubble formation, a gas can be flowed to the chamber, e.g., from a pressurized source, until the chamber reaches a pressure above the atmospheric pressure, such as 2, 5, or 10 atmospheric pressure. The control the reaction, e.g., periodically allowing the reaction by lower pressure for bubble formation, the gas in the chamber can be released, for example, through a connecting valve to the outside ambient, which is at atmospheric pressure.

Alternatively, the liquid can be operated to generate bubbles at sub-atmospheric pressure when contacting the surface of the object. To restrict the reaction, e.g., prohibiting the bubble formation, the chamber can be exposed to an atmospheric ambient. The control the reaction, e.g., periodically allowing the reaction by lower pressure for bubble formation, the gas in the chamber can be evacuated, for example, through a vacuum pump assembly.

In some embodiments, additional liquid can be added to the chamber, for example, to replenish or to restore the concentration of the liquid, which can be reduced due to the reaction with the object surface. In some embodiments, the object can be selectively heated, e.g., the object can be heated so that the object temperature can be higher than the temperature of the surrounding ambient, e.g., liquid.

In some embodiments, gases can be produced as a by-product in a chemical reaction between chemicals in the liquid and chemicals at the surface of a part being processed. For example, an object wetted with H₂O₂ can have the H₂O₂ on the object surface reacting with the sulfuric acid in the container tank. Alternatively, an object wetted with sulfuric acid can have the sulfuric acid reacting with the H₂O₂ in the container tank. The reaction between H₂O₂ and sulfuric acid can generate gaseous byproducts, and thus the reaction can be suppressed, for example, by a high pressure environment, and accelerated, for example, by a high vacuum environment.

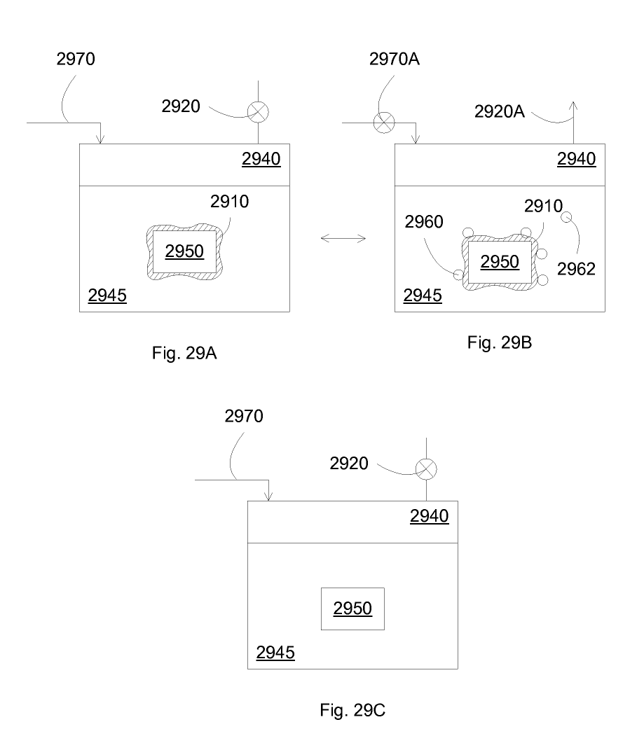

FIGS. 29A-29C illustrate an example of CNX using a gaseous reaction between a liquid in a container and a liquid on an object surface according to some embodiments of the current invention. In FIG. 29A, an object 2950 is submerged in a first liquid 2945 in a process chamber. As shown, the object is fully submerged. Other configurations can also be used, such as an object partially submerged in the liquid. A vapor portion 2940 can be present above the liquid portion 2945. The vapor portion 2940 can include a release valve 2920, which is closed. A gas 2970 can be provided to the vapor portion 2940, pressurizing the vapor portion. The gas 2970 can be coupled to a pressurized cylinder, which can flow to the process chamber. The gas 2970 can be any gases, such as air, CO₂, N₂, O₂, etc. The object 2950 can be covered with a second liquid 2910, for example, by wetting the object 2950 before or during the object submerged in the container. The first and second liquids are selected to react with each other to produce a gaseous byproduct. For example, a second liquid of hydrogen peroxide can be added to a first liquid of acid sulfuric to form a piranha solution. The two liquids can react to produce gases byproducts. Valve 2920 is close, and the pressure in the vapor portion 2940 is high, partially or fully stopping the reaction of the liquids.

In FIG. 29B, the gas delivery is stopped, for example, by closing valve 2970A, after reaching a desired pressure. For example, the desired pressure can be such that any bubbles in the liquid can be suppressed or terminated. The pressure can be at atmospheric or at higher than atmospheric pressure, e.g., 10-25 atm. Release valve 2920 is open, and byproduct gases 2920A can escape from the process chamber. For example, a vacuum pump can be coupled to the release valve 2920, and gases can be evacuated through the pumping action. Alternatively, the release valve 2920 can be open to atmosphere, and higher than atmospheric pressure within the process chamber can be reduced to atmospheric pressure through gas flow 2920A. With lower pressure in the vapor portion 2940, bubbles 2960 and 2962, which are the byproduct of the reaction of the first liquid 2945 with the second liquid 2910 on the object surface, can be formed in the liquid 2945.

In FIG. 29C, the process can be repeated. For example, release valve 2920 is close, and gas 2970 can be delivered to the process chamber. The gas flow 2970 can pressurize the vapor portion 2940, effectively terminating the bubbles 2960 and 2962. The process then continues, generating the bubbles at the object surface, terminating the bubbles, and re-generating bubbles to the liquid. The cyclic generating and terminating bubbles at the object surface can clean the object, especially at hard to reach surfaces. The process can be terminated when the second liquid is completely consumed, e.g., the reaction between the first and second liquids is stopped. In some embodiments, the second liquid can be replenished, for example, by rewetting the object.

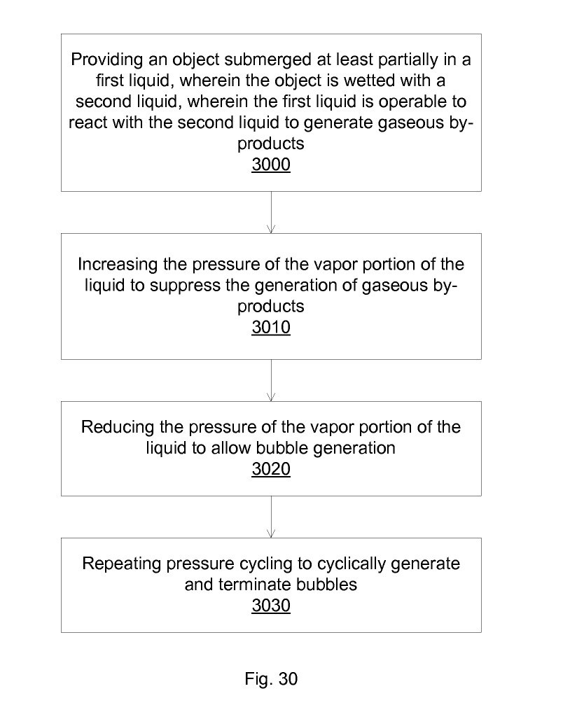

FIG. 30 illustrates a flowchart example of CNX using a gaseous reaction between a liquid in a container and a liquid on an object surface according to some embodiments of the current invention. In operation 3000, an object is submerged at least partially in a first liquid. The object can be submerged partially or fully in the first liquid. The object can be wetted with a second liquid. The first liquid and the second liquid are operable to react with each other to generate a gaseous byproduct. In operation 3010, the pressure of the vapor portion in the process chamber is increased to terminate or suppress the reaction between the two liquids, for example, by preventing the formation of bubbles in the process chamber. In operation 3020, the pressure is reduced to promote the reaction, or to generate bubbles in the liquids, especially at the object surface. For example, the gases can be evacuated by an aspirator or a vacuum pump. The gases can be released to atmosphere by opening a release valve, if the vapor portion is pressurized to above atmospheric pressure.

In operation 3030, pressure can be repeatedly applied to the vapor portion of the liquid, for example, by flowing gases to the vapor and/or liquid portions of the liquid. The process can be continued until the object is cleaned or until the reaction between the first and second liquids stops, or until the second liquid is completely consumed in the reaction with the first liquid. In some embodiments, the object can be rewetted with the second liquid, and the process can be repeated.

In some embodiments, a dynamic chamber process, which includes a dynamic chamber volume that can instantly change pressure conditions, can be used with the process. For example, a process fluid filled chamber can be equipped with a mechanical mechanism which can rapidly change the volume of the chamber. The chamber can be designed to be filled with process fluid, and can withstand pressure changes from vacuum to 2 or more atmospheres.

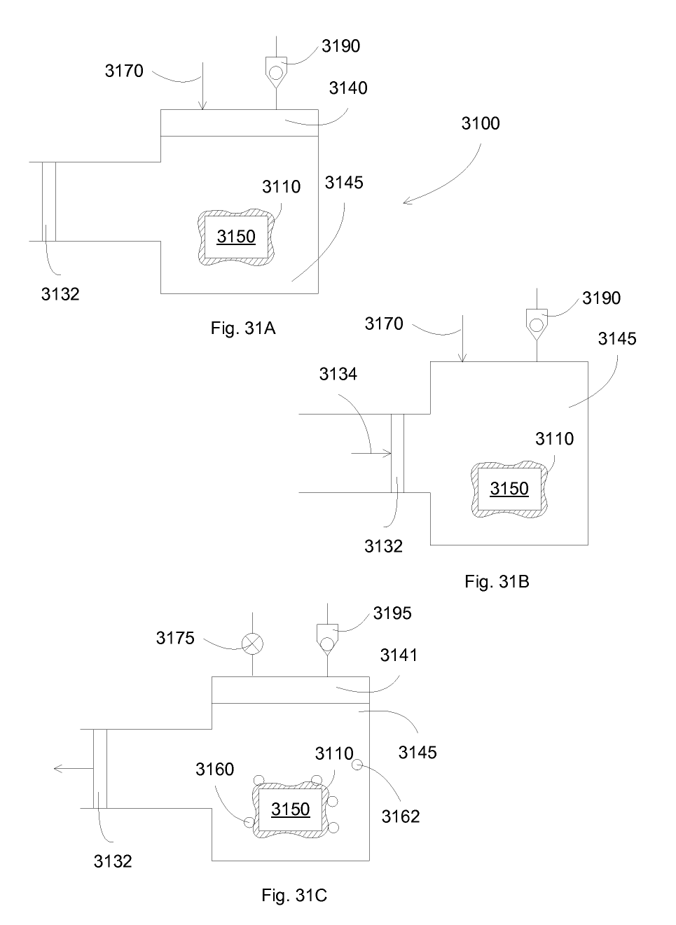

FIGS. 31A-31C illustrate an example of a dynamic chamber operation according to some embodiments of the current invention. In FIG. 31A, a dynamic chamber 3100 including a moveable wall 3132 is partially filled with a first liquid 3145, leaving a vapor portion 3140. An object 3150 can be partially or totally submerged in the liquid. A gas flow 3170 can be introduced to the dynamic chamber, for example, to pressurize the vapor portion 3140. The object can be wetted with a second liquid 3110. The first and second liquids can react with each other to generate gaseous byproducts. A check valve 3190 can be included to regulate the pressure of the vapor portion. Under the reaction between the first and second liquids, some bubbles of byproducts can be generated. In FIG. 31B, the moveable wall 3132 is compressed, pushing the vapor portion. The pressure increases and the reaction between the first and second liquids is suppressed. Excess gases can be released through the check valve 3190. Gas flow 3170 can continue to flow or can be shut off. In FIG. 31C, valve 3175 is closed, shutting off the gas flow 3170. The moveable wall 3132 can move to enlarge the volume of the chamber, generating vacuum head space 3141. Check valve can be closed 3195. Bubbles 3160 and 3162 can be generated, for example, at the object surface.

The cycle can be repeated, with the object occasionally re-wetted, for example, to replenish the consumption of the second liquid due to the reaction with the first liquid in the process chamber. The bubbles can be cyclically generated and terminated, due to the oscillation of pressure in the vapor portion 3140.

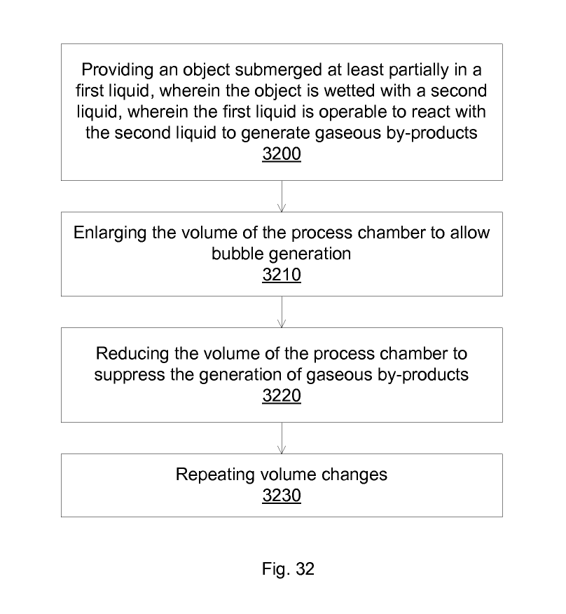

FIG. 32 illustrates a flowchart example of CNX using dynamic chamber according to some embodiments of the current invention. In operation 3200, an object can be loaded into a process chamber. The process chamber can be filled with a first liquid. The object can be wetted with a second liquid. The first and second liquids can be operable to react with each other to generate gaseous by-products. Operation 3210 enlarges the volume of the process chamber. Operation 3220 reduces the volume of the process chamber. Steps 3210 and 3220 can be executed in any order, such as enlarging before reducing or reducing before enlarging. Operation 3230 repeats the steps of volume enlarging and reducing for nucleation cleaning.

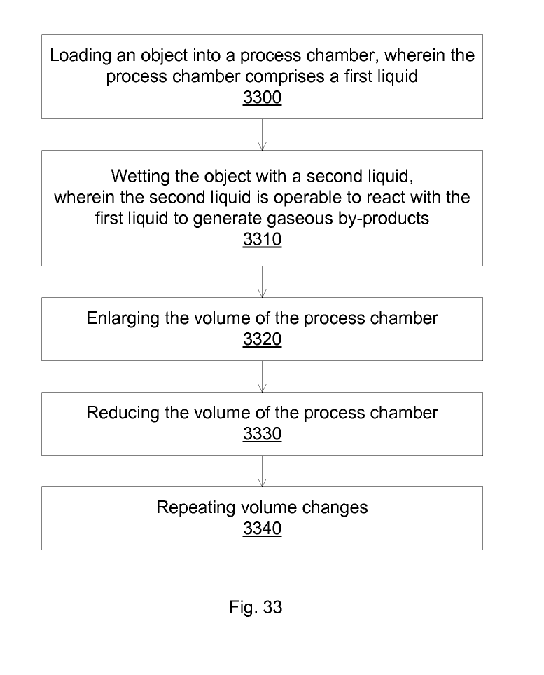

FIG. 33 illustrates a flowchart example of CNX using dynamic chamber according to some embodiments of the current invention. In operation 3300, an object can be loaded into a process chamber. The process chamber can be filled with a first liquid. Operation 3310 wets the object with a second liquid. The first and second liquids can be operable to react with each other to generate gaseous by-products. The object can be placed in to the process chamber. Operation 3320 enlarges the volume of the process chamber. Operation 3330 reduces the volume of the process chamber. Steps 3320 and 3330 can be executed in any order, such as enlarging before reducing or reducing before enlarging. Operation 3340 repeats the steps of volume enlarging and reducing for nucleation cleaning.

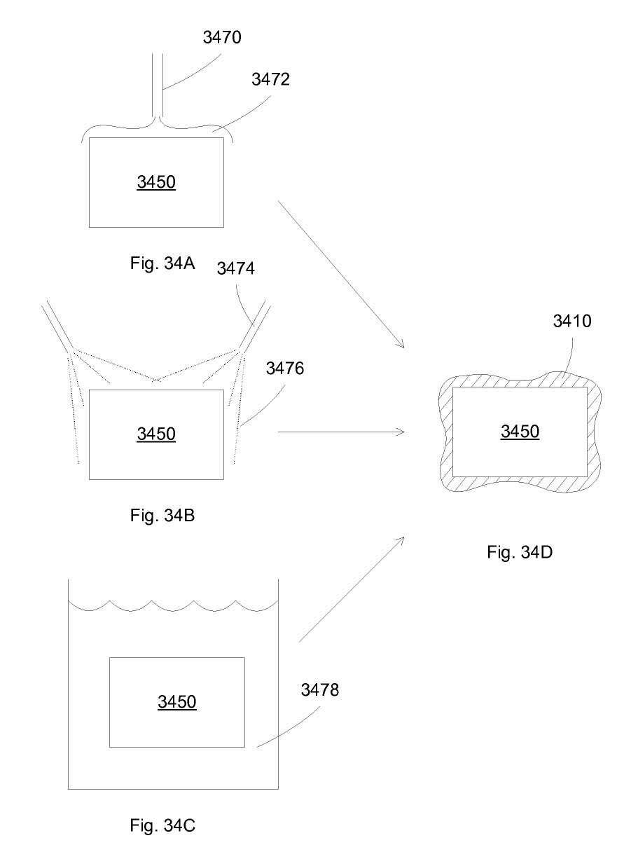

FIGS. 34A-34D illustrate an example of object wetting according to some embodiment of the present invention. In FIG. 34A, a nozzle 3470 can deliver a flow of liquid 3472 to an object 3450. In FIG. 34B, nozzles 3474 can provide a spray of liquid, or liquid vapor 3474 to the object 3450. In FIG. 34C, the object 3450 is submerged in a liquid 3478. In FIG. 34D, the object 3450 can include a layer of liquid or liquid vapor 3410 adhered to an outer surface of the object.

In some embodiments, the present invention discloses rewetting processes to replenish the liquid on the object surface, for example, to prolong the treatment, e.g., cleaning of the object. An object can be wetted, then bring to a process chamber to be cleaned. In the process chamber, the wetted liquid reacts with the surrounding liquid in the process chamber to generate bubbles. The pressure or volume of the process chamber can be changed cyclically, terminating and generating bubbles, which can clean the object surface. The wetted liquid can be consumed due to the reaction. The object can be rewetted, and the process continues, for example, to continue the cleaning process.

In some embodiments, the object can be wetted or rewetted by providing a liquid flow in the vicinity of the object. The liquid flow can occur in the liquid environment of the process chamber, or in a gaseous environment. For example, a liquid nozzle can be placed near the object, and a liquid flow can be provided, covering the object with the liquid.

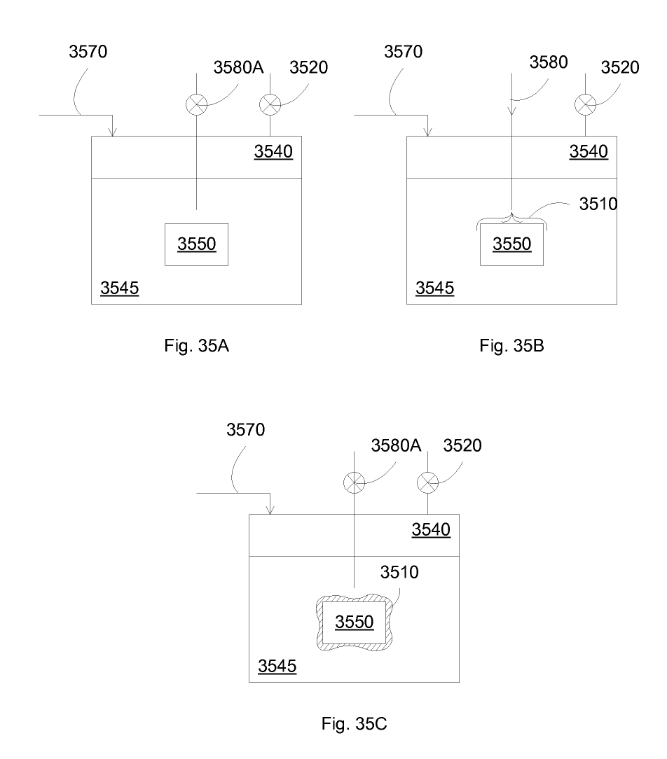

FIGS. 35A-35C illustrate an example of an object wetting process according to some embodiments of the current invention. In FIG. 35A, an object 3550 is submerged in a first liquid 3545 in a process chamber. As shown, the object is fully submerged. A vapor portion 3540 can be present above the liquid portion 3545. The vapor portion 3540 can include a release valve 3520, which is closed. A gas 3570 can be provided to the vapor portion 3540, pressurizing the vapor portion. A nozzle controlled by a valve 3580A can be provided to the process chamber, near the object surface.

In FIG. 35B, the valve 3580A is open, and a liquid 3510 can be introduced to the process chamber. The nozzle can be configured so that the liquid 3510 can be delivered near the object surface, wetting the object. For example, the liquid 3510 can be positioned at a top portion, and gravity can bring the liquid 3510 to the object. Alternatively, the liquid 3510 can be under pressure, and the jet flow of liquid can contact the object for wetting the object.

In FIG. 35C, the liquid flow can be stopped. The object is then covered with the liquid 3510. The cyclic cleaning of the object, for example, by repeating pressure or volume changes, can continue.

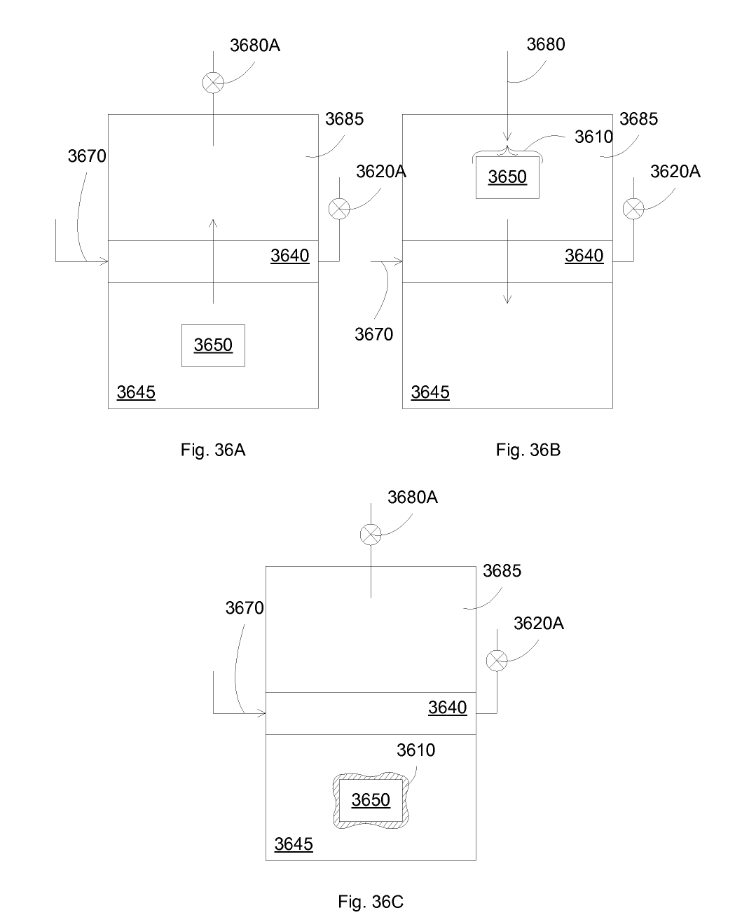

In some embodiments, the object can be wetted or rewetted after being removed from the liquid environment. FIGS. 36A-36C illustrate an example of an object wetting process according to some embodiments of the current invention. In FIG. 36A, an object 3650 is submerged in a first liquid 3645 in a process chamber. As shown, the object is fully submerged. A vapor portion 3640 can be present above the liquid portion 3645. The vapor portion 3640 can include a release valve 3620, which is closed. A gas 3670 can be provided to the vapor portion 3640, pressurizing the vapor portion. A nozzle controlled by a valve 3680A can be provided to a wetting chamber 3685 adjacent to the process chamber. The object can be removed from the process chamber, and brought to the wetting chamber 3685. In FIG. 36B, the valve 3680A is open, and a liquid 3610 can be introduced to the wetting chamber 3685. The nozzle can be configured so that the liquid 3610 can be delivered near the object surface, wetting the object. For example, the liquid 3610 can be positioned at a top portion, and gravity can bring the liquid 3610 to the object. Alternatively, the liquid 3610 can be under pressure, and the jet flow of liquid can contact the object for wetting the object. In FIG. 36C, the liquid flow can be stopped. The object is then covered with the liquid 3610 and returned to the process chamber. The cyclic cleaning of the object, for example, by repeating pressure or volume changes, can continue.

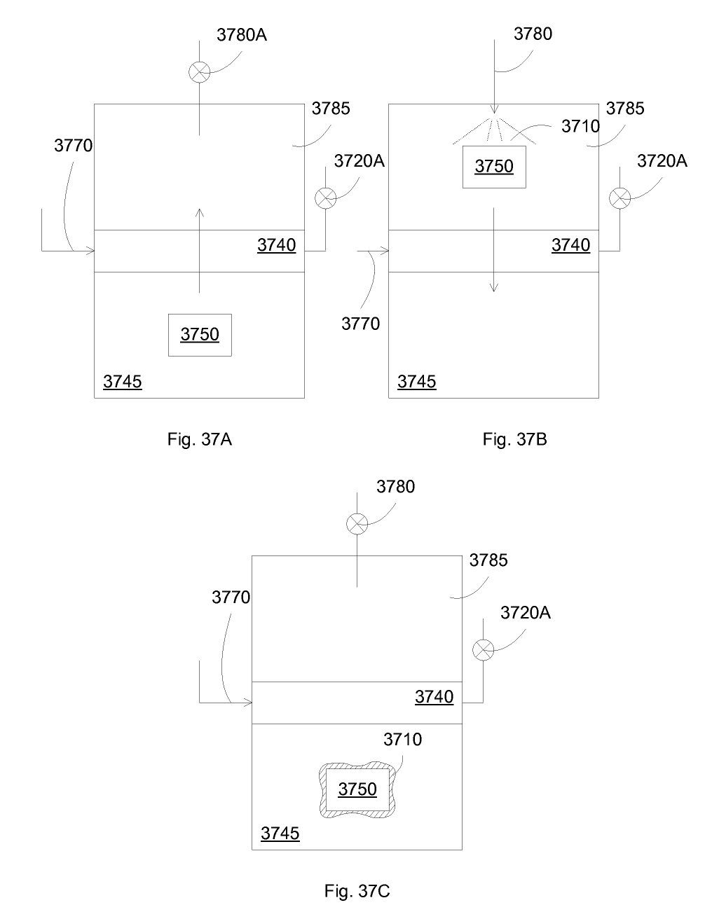

Other methods to wet the object in the wetting chamber can be used, such as liquid spray, liquid misting, or the wetting chamber can be filled with liquid vapor so that by being in the wetting chamber, the liquid can be condensed on the object. FIGS. 37A-37C illustrate an example of an object wetting process according to some embodiments of the current invention. In FIG. 37A, an object 3750 is submerged in a first liquid 3745 in a process chamber. A vapor portion 3740 can be present above the liquid portion 3745. The vapor portion 3740 can include a release valve 3720, which is closed. A gas 3770 can be provided to the vapor portion 3740, pressurizing the vapor portion. A nozzle controlled by a valve 3780A can be provided to a wetting chamber 3785 adjacent to the process chamber. The object can be removed from the process chamber, and brought to the wetting chamber 3785. In FIG. 37B, the valve 3780A is open, and a liquid vapor 3710 can be sprayed onto the object. In FIG. 37C, the liquid flow can be stopped. The object is then covered with the liquid 3710 and returned to the process chamber. The cyclic cleaning of the object, for example, by repeating pressure or volume changes, can continue.

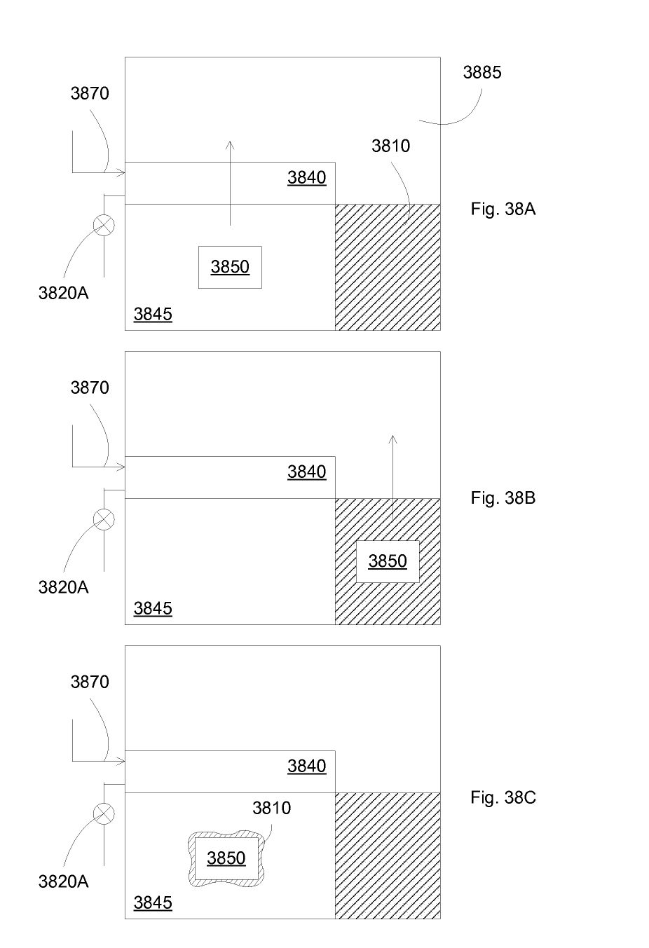

In some embodiments, the object can be wetted or rewetted by submerging in another liquid environment. FIGS. 38A-38C illustrate an example of an object wetting process according to some embodiments of the current invention. In FIG. 38A, an object 3850 is submerged in a first liquid 3845 in a process chamber. As shown, the object is fully submerged. A vapor portion 3840 can be present above the liquid portion 3845. The vapor portion 3840 can include a release valve 3820, which is closed. A gas 3870 can be provided to the vapor portion 3840, pressurizing the vapor portion. A nozzle controlled by a valve 3880A can be provided to a wetting chamber 3885 adjacent to the process chamber. The object can be removed from the process chamber, and brought to the wetting chamber 3885. In FIG. 38B, the object is submerged in the wetting chamber, which is filled with liquid 3810. In FIG. 38C, the object is returned to the process chamber, covering with the liquid 3810. The cyclic cleaning of the object, for example, by repeating pressure or volume changes, can continue.

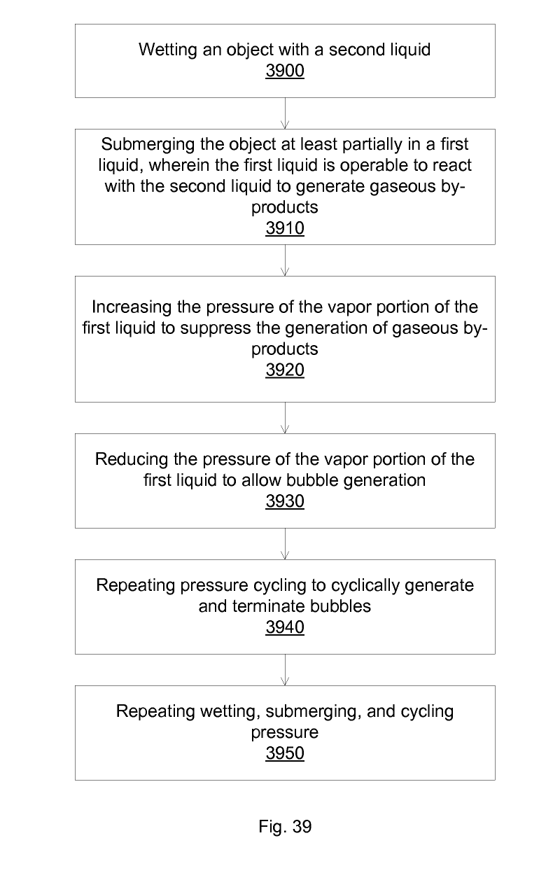

FIG. 39 illustrates a flowchart example of CNX using a gaseous reaction between a liquid in a container and a liquid on an object surface according to some embodiments of the current invention. In operation 3900, an object is wetted with a second liquid. In operation 3910, the object is submerged at least partially in a first liquid. The object can be submerged partially or fully in the first liquid. The first liquid and the second liquid are operable to react with each other to generate a gaseous byproduct. In operation 3920, the pressure of the vapor portion in the process chamber is increased to terminate or suppress the reaction between the two liquids, for example, by preventing the formation of bubbles in the process chamber. In operation 3930, the pressure is reduced to promote the reaction, or to generate bubbles in the liquids, especially at the object surface. For example, the gases can be evacuated by an aspirator or a vacuum pump. The gases can be released to atmosphere by opening a release valve, if the vapor portion is pressurized to above atmospheric pressure.

In operation 3940, pressure can be repeatedly applied to the vapor portion of the liquid, for example, by flowing gases to the vapor and/or liquid portions of the liquid. The process can be continued until the object is cleaned or until the reaction between the first and second liquids stops, or until the second liquid is completely consumed in the reaction with the first liquid. In operation 3950, the object can be rewetted with the second liquid, and the process can be repeated.

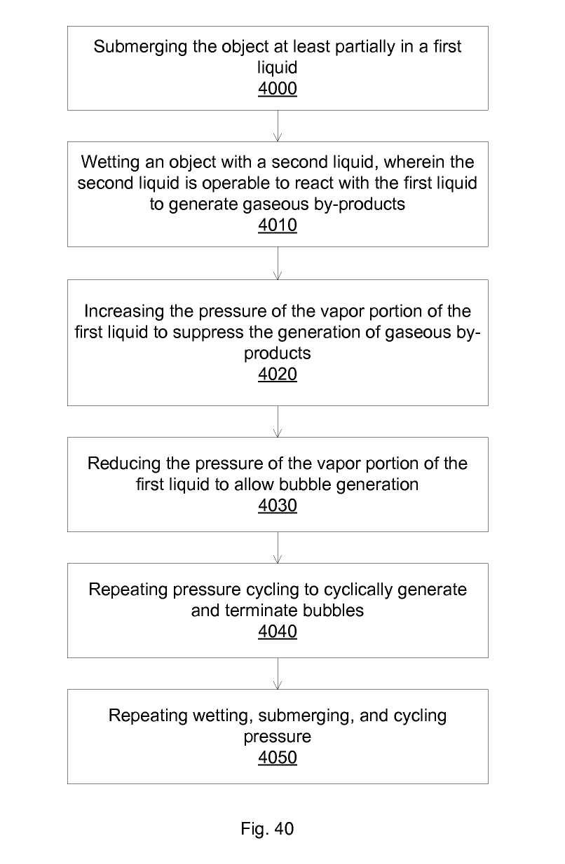

FIG. 40 illustrates a flowchart example of CNX using a gaseous reaction between a liquid in a container and a liquid on an object surface according to some embodiments of the current invention. In operation 4000, an object is submerged at least partially in a first liquid. The object can be submerged partially or fully in the first liquid. In operation 4010, the object is wetted with a second liquid. The first liquid and the second liquid are operable to react with each other to generate a gaseous byproduct. In operation 4020, the pressure of the vapor portion in the process chamber is increased to terminate or suppress the reaction between the two liquids, for example, by preventing the formation of bubbles in the process chamber. In operation 4030, the pressure is reduced to promote the reaction, or to generate bubbles in the liquids, especially at the object surface. For example, the gases can be evacuated by an aspirator or a vacuum pump. The gases can be released to atmosphere by opening a release valve, if the vapor portion is pressurized to above atmospheric pressure.

In operation 4040, pressure can be repeatedly applied to the vapor portion of the liquid, for example, by flowing gases to the vapor and/or liquid portions of the liquid. The process can be continued until the object is cleaned or until the reaction between the first and second liquids stops, or until the second liquid is completely consumed in the reaction with the first liquid. In operation 4050, the object can be rewetted with the second liquid, and the process can be repeated.

In some embodiments, provided are methods and systems to clean an object in a liquid, including cyclically stopping and releasing bubbles that can be formed by a reaction of the liquid with another liquid coating the object. The stopping of bubble formation can control the rate of reaction between the two liquids, which can improve the effectiveness of the reaction of the liquids.

In some embodiments, the methods can include providing a chamber containing a first liquid. The chamber can be configured to be sealed. The first liquid can totally or partially fill the chamber, for example, forming a vapor portion and a liquid portion in the chamber. The first liquid can be selected to react with a second liquid coating the surface of the object. Further, the reaction of the liquids can generate bubbles, e.g., gaseous component by-products. In some embodiments, the two liquids can include sulfuric acid and hydrogen peroxide. For example, the first liquid can include sulfuric acid and the second liquid can include hydrogen peroxide. Alternatively, the first liquid can include hydrogen peroxide and the second liquid can include sulfuric acid.

The wetted object can be submerged in first the liquid, either totally submerged or partially submerged. The first liquid and the wetted object can be placed in the chamber at a same time, or sequentially one after the other. For example, the wetted object can be introduced to the first liquid already existed in the chamber. The wetted object can be placed in the chamber and then the first liquid can be added to chamber.

The chamber pressure can increase, for example, by flowing a gas to the chamber. The high pressure can stop or slow the reaction of the liquids, for example, by restricting the formation of the bubbles. Further, the high pressure can terminate any existing bubbles in the liquid.

The chamber pressure can decrease, for example, by removing the gas in the chamber. The low pressure can promote the reaction of the liquids, for example, by allowing the formation of the bubbles. The bubbles can be generated at the object surface, which can be used to clean the object surface.

For example, the first liquid can be operated to generate bubbles at atmospheric pressure when contacting the wetted surface of the object, e.g., reacting with the second liquid on the object surface. To restrict the reaction, e.g., prohibiting the bubble formation, a gas can be flowed to the chamber, e.g., from a pressurized source, until the chamber reaches a pressure above the atmospheric pressure, such as 2, 5, or 10 atmospheric pressure. The control the reaction, e.g., periodically allowing the reaction by lower pressure for bubble formation, the gas in the chamber can be released, for example, through a connecting valve to the outside ambient, which is at atmospheric pressure.

Alternatively, the first liquid can be operated to generate bubbles at sub-atmospheric pressure when contacting the wetted surface of the object. To restrict the reaction, e.g., prohibiting the bubble formation, the chamber can be exposed to an atmospheric ambient. The control the reaction, e.g., periodically allowing the reaction by lower pressure for bubble formation, the gas in the chamber can be evacuated, for example, through a vacuum pump assembly.

In some embodiments, additional liquids can be added to the chamber, for example, to replenish or to restore the concentration of the liquids, which can be reduced due to the reaction between the liquids. In some embodiments, the object can be re-wetted, e.g., to re-coating the object surface with the second liquid. In some embodiments, the object can be selectively heated, e.g., the object can be heated so that the object temperature can be higher than the temperature of the surrounding ambient, e.g., liquid.

What is claimed is:

1. A method for cleaning objects, the method comprising
providing a chamber containing a liquid;
submerging an object in the liquid, wherein the object is at least partially submerged;
flowing a gas to the chamber, wherein the gas is delivered from a pressurized source;
removing a portion of the gas from the chamber to form bubbles in the liquid;
repeating flowing and removing processes.

2. A method as in claim 1 wherein the gas is flowed to a vapor portion in the chamber or to a liquid portion in the chamber.

3. A method as in claim 1 wherein the pressurized source comprises a pressurized cylinder or a compressed gas system.

4. A method as in claim 1 wherein a portion of the flowed gas is dissolved in the liquid, wherein the ratio of the concentration of the gas in a liquid portion of the chamber and the concentration of the gas in a vapor portion of the chamber is greater than 1 percent.

5. A method as in claim 1 wherein the gas comprises at least one of CO₂, NH₃, SO₂, H₂S, O₂, N₂, or He.

6. A method as in claim 1 wherein the gas is flowed to the chamber to reach a chamber pressure of atmospheric pressure or higher.

7. A method as in claim 1 wherein the gas is flowed to the chamber to reach a chamber pressure of higher than 2 atmospheric pressure.

8. A method as in claim 1
wherein removing the gas comprises evacuating the gas from a vapor portion of the chamber by a vacuum assembly, or
wherein removing the gas comprises releasing the gas from a vapor portion of the chamber to an outside ambient.

9. A method as in claim 1 wherein removing the gas comprises repeatedly
releasing the gas from a vapor portion of the chamber to an outside ambient, and
stopping releasing the gas.

10. A method as in claim 1 further comprising
selectively heating the object.

11. A method for cleaning objects, the method comprising
providing a chamber containing a liquid;
submerging an object in the liquid, wherein the object is at least partially submerged, wherein the liquid is operated to generate bubbles when contacting a surface of the object;
increasing the pressure of the chamber to terminate the bubbles;
reducing the pressure of the chamber to generate bubbles;
repeating increasing and reducing pressure.

12. A method as in claim 11 wherein the object comprises a silicon-containing surface, wherein the liquid comprises KOH.

13. A method as in claim 11 wherein the object comprises an organic contaminated surface, wherein the liquid comprises hydrogen peroxide.

14. A method as in claim 11
wherein the liquid is operated to generate bubbles at atmospheric pressure when contacting the surface of the object,
wherein increasing the pressure comprises flowing a gas to the chamber.
wherein reducing the pressure comprises releasing gases in a vapor portion of the chamber.

15. A method as in claim 11
wherein the liquid is operated to generate bubbles at sub-atmospheric pressure when contacting the surface of the object.
wherein increasing the pressure comprises exposing the chamber to an atmospheric ambient.
wherein reducing the pressure comprises evacuate gases in a vapor portion of the chamber.

16. A method for cleaning objects, the method comprising
providing a chamber containing a first liquid;
submerging an object in the first liquid,
wherein the object is at least partially submerged,
wherein the object is wetted with a second liquid,
wherein the second liquid is operated to generate bubbles when reacting with the first liquid;
increasing the pressure of the chamber to terminate the bubbles;
reducing the pressure of the chamber to generate bubbles;
repeating increasing and reducing pressure.

17. A method as in claim 16
wherein the first liquid comprises sulfuric acid and the second liquid comprises hydrogen peroxide, or
wherein the first liquid comprises hydrogen peroxide and the second liquid comprises sulfuric acid.

18. A method as in claim 1
wherein the first liquid is operated to generate bubbles at atmospheric pressure when reacting with the second liquid,
wherein increasing the pressure comprises flowing a gas to the chamber.
wherein reducing the pressure comprises releasing gases in a vapor portion of the chamber.

19. A method as in claim 16
wherein the first liquid is operated to generate bubbles at sub-atmospheric pressure when reacting with the second liquid,
wherein increasing the pressure comprises exposing the chamber to an atmospheric ambient.
wherein reducing the pressure comprises evacuate gases in a vapor portion of the chamber.

20. A method as in claim 16 further comprising at least one of
adding the second liquid to the chamber, or
re-wetting the object with the second liquid.
